(19) United States
(12) Patent Application Publication
(10) Pub. No.: US 2025/0227133 A1
(43) Pub. Date: Jul. 10, 2025

(54) ELECTRONIC DEVICE FOR PROVIDING AUDIO SERVICE AND METHOD FOR OPERATING SAME

(71) Applicant: Samsung Electronics Co., Ltd., Suwon-si (KR)

(72) Inventors: Heejae YOON, Suwon-si (KR); Gupil CHEONG, Suwon-si (KR); Sungjun CHOI, Suwon-si (KR); Doosuk KANG, Suwon-si (KR); Hyungseoung YOO, Suwon-si (KR)

(21) Appl. No.: 19/091,372

(22) Filed: Mar. 26, 2025

(30) Foreign Application Priority Data
Sep. 27, 2022 (KR) 10-2022-0122637
Nov. 29, 2022 (KR) 10-2022-0163132

(51) Int. Cl. H04L 65/1069; H04L 65/611

(52) U.S. Cl. CPC H04L 65/1069; H04L 65/611

(57) ABSTRACT

An electronic device may include a communication circuit and at least one processor comprising processing circuitry. The at least one processor may be individually and/or collectively configured to: connect a communication link with an external electronic device; perform audio relay negotiation for audio service with the external electronic device over the communication link; receive at least one first data packet broadcast from a source electronic device; transmit, to the external electronic device through the communication link, reception indication information related to the audio service, on the basis of the audio relay negotiation; on the basis of the audio relay negotiation, receive, from the external electronic device, relay data including at least one second data packet that the external electronic device has received from the source electronic device; and output audio on the basis of the at least one first data packet and the at least one second data packet.

### CROSS-REFERENCE TO RELATED APPLICATIONS

This application is a continuation application of International Application No. PCT/KR2023/014570 designating the United States, filed on Sep. 22, 2023, in the Korean Intellectual Property Receiving Office and claiming priority to Korean Patent Application No. 10-2022-0122637, filed on Sep. 27, 2022, and Korean Patent Application No. 10-2022-0163132, filed on Nov. 29, 2022, the disclosures of which are all hereby incorporated by reference herein in their entireties.

### BACKGROUND

### Technical Field

Various example embodiments may relate to an electronic device for providing an audio service and/or a method for operating the same.

### Description of Related Art

Bluetooth communication technology may suggest a short-range wireless communication technology that enables electronic devices to be connected to each other for exchanging data or information. Bluetooth communication technology may have Bluetooth legacy (or classic) communication technology or Bluetooth low energy (BLE) communication technology and have various kinds of topology, such as piconet or scatternet.

Recently in wide use are electronic devices adopting Bluetooth communication technology. For example, a pair of earbuds that may be respectively worn on both ears of the user are widely used as an ear-wearable device. An ear-wearable device may provide various functions. For example, an ear-wearable device may include a microphone to identify the user's voice, thereby transmitting data for the user's voice to an electronic device (e.g., a smartphone). Further, the ear-wearable device may include a speaker to output the audio data received from an electronic device (e.g., a smartphone) to through the speaker.

The ear-wearable device may include a primary earbud (e.g., the right earbud) and a secondary earbud (e.g., the left earbud) that may be connected to an electronic device (e.g., a smart phone). The primary earbud may transmit voice data to the electronic device through connection with the electronic device, and the electronic device may transmit audio data (or audio content) to the primary earbud. The primary earbud may transfer audio data (or audio content) received from the electronic device through wireless communication to the secondary earbud and may output the audio data through the speaker. The secondary earbud may be synchronized with the primary earbud, outputting the audio data transferred from the primary earbud or electronic device through the speaker.

The primary earbud and the secondary earbud (hereinafter referred to as ‘earbuds’) may be connected to the electronic device based on Bluetooth communication to perform the above operations. To that end, the earbuds may perform pairing including an inquiry and/or an inquiry scan, or a BLE advertising and/or BLE scan.

The BLE advertising may mean an operation for periodically broadcasting an advertising packet through an advertising physical channel, and the BLE scan may mean an operation for monitoring reception of the advertising packet.

### SUMMARY

An electronic device and an operation method thereof according to various example embodiments may receive audio data broadcast from a source electronic device.

The electronic device and the operation method thereof according to various example embodiments may share a reception state between electronic devices receiving a broadcast stream.

The electronic device and the operation method thereof according to various example embodiments may transfer (relay) audio data broadcast from a source electronic device to an external electronic device.

An electronic device according to an example embodiment may comprise communication circuitry and at least one processor, comprising processing circuitry, operatively connected, directly or indirectly, to the communication circuitry. The at least one processor may be individually and/or collectively configured to establish a communication link with an external electronic device through the communication circuitry. The at least one processor may be individually and/or collectively configured to perform at least part of an audio relay negotiation for an audio service with the external electronic device through the communication link. The at least one processor may be individually and/or collectively configured to receive at least one first data packet broadcast from a source electronic device. The at least one processor may be individually and/or collectively configured to transmit reception indication information related to the audio service to the external electronic device through the communication link based on the audio relay negotiation. The at least one processor may be individually and/or collectively configured to receive, from the external electronic device, relay data including at least one second data packet received from the source electronic device by the external electronic device based on the audio relay negotiation. The at least one processor may be individually and/or collectively configured to output an audio based on the at least one first data packet and the at least one second data packet.

An electronic device according to an example embodiment may comprise communication circuitry and at least one processor operatively connected, directly or indirectly, to the communication circuitry. The at least one processor may be configured to establish a communication link with an external electronic device through the communication circuitry. The at least one processor may be configured to perform audio relay negotiation for an audio service with the external electronic device through the communication link. The at least one processor may be configured to receive at least one first data packet broadcast from a source electronic device. The at least one processor may be configured to identify whether reception indication information related to the audio service is received from the external electronic device through the communication link based on the audio relay negotiation. The at least one processor may be configured to transmit, to the external electronic device, relay data including the at least one first data packet received from the source electronic device based on the audio relay negotiation, based on the reception indication information.

A method for operating an electronic device according to an example embodiment may comprise connecting a communication link with an external electronic device. The method may comprise performing audio relay negotiation for an audio service with the external electronic device through the communication link. The method may comprise receiving at least one first data packet broadcast from a source electronic device. The method may comprise transmitting reception indication information related to the audio service to the external electronic device through the communication link based on the audio relay negotiation. The method may comprise receiving, from the external electronic device, relay data including at least one second data packet received from the source electronic device by the external electronic device based on the audio relay negotiation. The method may comprise outputting an audio based on the at least one first data packet and the at least one second data packet.

A method for operating an electronic device according to an example embodiment may comprise connecting a communication link with an external electronic device. The method may comprise performing audio relay negotiation for an audio service with the external electronic device through the communication link. The method may comprise receiving at least one first data packet broadcast from a source electronic device. The method may comprise identifying whether reception indication information related to the audio service is received from the external electronic device through the communication link based on the audio relay negotiation. The method may comprise transmitting, to the external electronic device, relay data including the at least one first data packet received from the source electronic device based on the audio relay negotiation, based on the reception indication information.

According to an example embodiment, in a non-transitory computer-readable storage medium storing one or more programs, the one or more programs may include instructions to, when executed by at least one processor of an electronic device, enable the electronic device to connect a communication link with an external electronic device), perform audio relay negotiation for an audio service with the external electronic device through the communication link, receive at least one first data packet broadcast from a source electronic device, transmit reception indication information related to the audio service to the external electronic device through the communication link based on the audio relay negotiation, receive, from the external electronic device, relay data including at least one second data packet received from the source electronic device by the external electronic device based on the audio relay negotiation, and output an audio based on the at least one first data packet and the at least one second data packet.

According to an example embodiment, in a non-transitory computer-readable storage medium storing one or more programs, the one or more programs may include instructions to, when executed by at least one processor of an electronic device, enable the electronic device to connect a communication link with an external electronic device, perform audio relay negotiation for an audio service with the external electronic device through the communication link, receive at least one first data packet broadcast from a source electronic device, identify whether reception indication information related to the audio service is received from the external electronic device through the communication link based on the audio relay negotiation, and transmit, to the external electronic device, relay data including the at least one first data packet received from the source electronic device based on the audio relay negotiation, based on the reception indication information.

### BRIEF DESCRIPTION OF THE DRAWINGS

FIG. 1 is a view illustrating an electronic device in a network environment according to an example embodiment;

FIG. 2 is a view illustrating a connection between electronic devices based on a Bluetooth scheme according to an example embodiment;

FIG. 3 is a view illustrating a configuration of an electronic device supporting Bluetooth communication according to an example embodiment;

FIG. 4 is a signal flowchart illustrating a procedure for synchronizing with a broadcast isochronous group (BIG), according to an example embodiment;

FIG. 5 is a view illustrating a format of BIG information according to an example embodiment;

FIG. 6 is a view illustrating a BIG event for a periodic advertising event according to an example embodiment;

FIG. 7 is a view illustrating a BIG and BIS events according to an example embodiment;

FIGS. 8A, 8B, and 8C are views illustrating retransmission of BIS data packets according to an example embodiment;

FIGS. 9A, 9B, and 9C are views illustrating a system structure transmitting audio data according to various example embodiments;

FIG. 10 is a view illustrating a configuration of an external electronic device relaying audio data according to an example embodiment;

FIGS. 11A and 11B are signal flowcharts illustrating a procedure of sharing a reception state between sink electronic devices according to an example embodiment;

FIG. 12 is a flowchart illustrating an operation of an electronic device transmitting reception indication identification information according to an example embodiment;

FIG. 13 is a flowchart illustrating an operation of an external electronic device 910 receiving reception indication identification information according to an example embodiment;

FIG. 14 is a view illustrating periodic advertising according to an example embodiment;

FIG. 15 is a view illustrating audio relay negotiation according to an example embodiment;

FIGS. 16A, 16B, and 16C are views illustrating a format of reception indication identification information according to an example embodiment;

FIG. 17A is a view illustrating an operation of transmitting reception identification information according to an example embodiment;

FIG. 17B is a view illustrating an operation of transmitting non-reception identification information according to an example embodiment;

FIG. 18 is a view illustrating an operation of transmitting reception indication identification information after a BIS event according to an example embodiment;

FIG. 19 is a view illustrating an operation of relaying missing audio data according to an example embodiment;

FIG. 20 is a view illustrating an operation of relaying missing audio data after a BIS event according to an example embodiment;

FIG. 21 is a view illustrating an operation of mandatorily relaying audio data by an external electronic device according to an example embodiment;

FIG. 22 is a view illustrating an operation of mandatorily relaying audio data based on BIS information about a source electronic device by an external electronic device according to an example embodiment; and

FIG. 23 is a view illustrating an operation of relaying audio data through a new BIG by an external electronic device according to an example embodiment.

### DETAILED DESCRIPTION

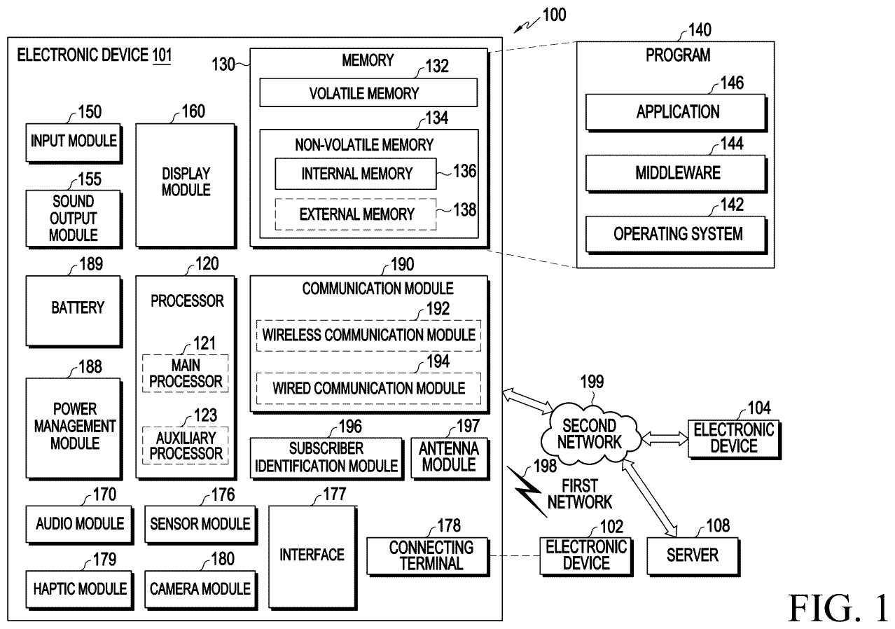

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108.

According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

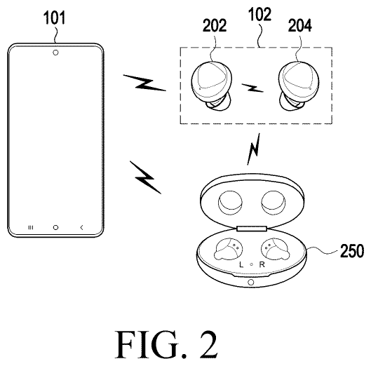

FIG. 2 is a view illustrating a connection between electronic devices based on a Bluetooth scheme according to an embodiment.

Referring to FIG. 2, an electronic device (e.g., an ear-wearable device) may be wirelessly connected to an external electronic device (e.g., the electronic device 101). In an embodiment, the external electronic device 101 may be a smartphone, tablet, or laptop computer. In an embodiment, the electronic device 102 is a binaural ear-wearable device and may include at least one of a first electronic device 202 (e.g., a left earbud) and a second electronic device 204 (e.g., a right earbud).

In an embodiment, the first electronic device 202 and the second electronic device 204 are shown as a pair of earbuds, but the first electronic device 202 and the second electronic device 204 may include not only earbuds but also devices capable of operating in pair. According to an embodiment, the first electronic device 202 and the second electronic device 204 may be implemented to include the same or similar components to each other.

According to an embodiment, the external electronic device 101 may establish a connection (e.g., a communication link) with at least one of the first electronic device 202 or the second electronic device 204 and transmit and/or receive data to/from each other. For example, the external electronic device 101 may establish a communication link with at least one of the first electronic device 202 and the second electronic device 204 based on a Wi-Fi scheme or a Bluetooth scheme (e.g., Bluetooth classic or Bluetooth low energy (BLE)). However, the scheme in which the external electronic device 101 establishes a communication link with the first electronic device 202 and the second electronic device 204 is not limited to at least one of a Wi-Fi scheme and/or a Bluetooth scheme.

In an embodiment, the external electronic device 101 may establish a communication link with only one of the first electronic device 202 or the second electronic device 204 or establish an individual communication link with each of the first electronic device 202 and the second electronic device 204.

In an embodiment, the external electronic device 101 may play a role as central (or master, primary device, or main), and the electronic device 102 (e.g., at least one of the first electronic device 202 or the second electronic device 204) may play a role as peripheral (or slave or secondary). The external electronic device 101 operating as a central may transmit data to an electronic device (e.g., the first electronic device 202 or the second electronic device 204) operating as a peripheral. For example, when the external electronic device 101 and the first electronic device 202 establish a communication link with each other, the external electronic device 101 may be selected as central, and the first electronic device 202 may be selected as peripheral. In the case of an audio service, the external electronic device 101 operating as a central may be a source electronic device, and the electronic device operating as a peripheral (e.g., the first electronic device 202 or the second electronic device 204) may be a sink electronic device.

In an embodiment, the first electronic device 202 and the second electronic device 204 may establish a communication link between each other based on at least one of a Wi-Fi scheme and/or a Bluetooth scheme, but the method in which the first electronic device 202 and the second electronic device 204 establish a communication link is not limited to at least one of the Wi-Fi scheme and/or the Bluetooth scheme.

In an embodiment, one of the first electronic device 202 and the second electronic device 204 may operate as a central (or primary device), and the other may operate as a peripheral (or secondary device). The electronic device (e.g., the electronic device 202) operating as a central may transmit data (e.g., a reception identification signal or relay data) to the electronic device (e.g., the electronic device 204) operating as a peripheral. For example, when the electronic device 202 and the electronic device 204 establish a communication link with each other, one of the electronic device 202 and the electronic device 204 may be randomly selected as a central, and the other may be selected as peripheral.

The electronic device 202 and the electronic device 204 may communicate directly or indirectly with the external electronic device 250. In an embodiment, the external electronic device 250 may be an ear buds case device or cradle device for storing and charging the first electronic device 202 and the second electronic device 204.

According to an embodiment, the external electronic device 250 may establish a connection (e.g., a communication link) with at least one of the external electronic device 101, the first electronic device 202 or the second electronic device 204 and transmit and/or receive data to/from each other. For example, the external electronic device 250 may establish a communication link with at least one of the external electronic device 101, the first electronic device 202, or the source electronic device 204 based on a Wi-Fi scheme or a Bluetooth scheme (e.g., Bluetooth classic or Bluetooth low energy (BLE)), but the scheme in which the external electronic device 250 establishes a communication link with the external electronic device 101, the first electronic device 202, or the source electronic device 204 is not limited to at least one of the Wi-Fi scheme and/or the Bluetooth scheme.

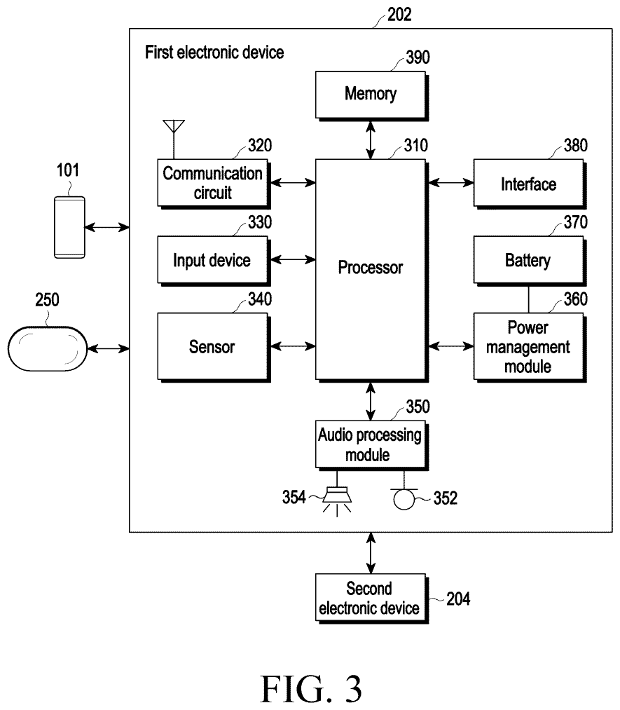

FIG. 3 is a view illustrating a configuration of an electronic device supporting Bluetooth communication according to an embodiment.

Referring to FIG. 3, the external electronic device 101 may be wirelessly connected to the electronic devices 202 and 204. The external electronic device 101 may be implemented as, e.g., a smart phone but, without limited to those described and/or shown, may be implemented as various types of devices (e.g., notebook computers including standard laptop computers, Ultrabook, or tab books, laptop computers, tablet computers, or desktop computers). The external electronic device 101 may be implemented as shown in FIG. 1 and may thus include at least some of the components (e.g., various modules) shown in FIG. 1, and no duplicate description thereof is thus given below.

The electronic devices 202 and 204 may be implemented as wireless earbuds but, without limited to those described and/or shown, may be implemented as various types of devices (e.g., a smart watch, a head-mounted display device, or devices for measuring biometric signals (e.g., heartrate patch)) that supports an audio service as described below. According to an embodiment, when the electronic devices 202 and 204 are wireless earbuds, the first electronic device 202 and the second electronic device 204 may be a pair of devices (e.g., a left earbud and a right earbud). According to an embodiment, the first electronic device 202 and the second electronic device 204 may be implemented to include the same or similar components.

According to an embodiment, the external electronic device 101 may establish a communication connection with at least one of the electronic devices 202 and 204 and transmit and/or receive data to/from each other. For example, each of the electronic devices 202 and 204 may use device-to-device (D2D) communication, such as Wi-Fi direct or Bluetooth, (e.g., using a communication circuit (e.g., the communication circuitry 320) supporting the corresponding communication scheme) to establish a communication connection with the external electronic device 101 but, without limited thereto, may communicate with each other using other various types of communication (e.g., a communication scheme such as Wi-Fi using access points (APs), a cellular communication scheme using base stations, or a wired communication scheme).

In an embodiment, one of the first electronic device 202 and the second electronic device 204 may be a primary device (or a master device or a main device), and the other device may be a secondary device (or a slave device or a sub device). The primary device (or the main device) may transmit data to the secondary device. For example, when the first electronic device 202 and the second electronic device 204 establish a communication connection with each other, any one of the first electronic device 202 and the second electronic device 204 may be randomly selected as the primary device, and the other may be selected as the secondary device. In an embodiment, when the first electronic device 202 and the second electronic device 204 establish a communication connection therebetween, the device detected as first worn (e.g., when a value indicating wearing is detected by a wearing detection sensor (e.g., a proximity sensor, a touch sensor, a slope 6-axis sensor, or a 9-axis sensor)) may be selected as the primary device, and the other as the secondary device.

In an embodiment, the primary device may transmit data received from the external electronic device 101 to the secondary device. For example, the first electronic device 202, which is the primary device, may not only output audio to the speaker 354 based on audio data received from the external electronic device 101, but also output the audio data to the second electronic device which is the secondary device. In an embodiment, the source electronic device 204 which is the secondary device may receive, through sniffing, the audio data, transmitted from the external electronic device 101 to the primary device (e.g., the first electronic device 202), based on the connection information provided from the primary device (e.g., the first electronic device 202).

In an embodiment, the first electronic device 202 which is the primary device may transmit the data (e.g., audio data or control data) received from the second electronic device 204 which is the secondary device to the external electronic device 101. For example, when a touch event occurs in the second electronic device 204 which is the secondary device, control data including information about the event may be transmitted to the external electronic device 101 by the first electronic device 202 which is the primary device. However, without limited to those described, the secondary device (e.g., the source electronic device 204) and the external electronic device 101 may establish a communication connection therebetween as described above, so that the secondary device and the external electronic device 101 may directly perform transmission and/or reception of data therebetween.

In an embodiment, the first electronic device 202 may include the same or similar components to at least one of the components (e.g., modules) of the external electronic device 101 illustrated in FIG. 1. The first electronic device 202 may include a processor 310 (e.g., the processor 120 of FIG. 1), communication circuitry 320 (e.g., the communication module 190 of

FIG. 1), an input device 330 (e.g., the input module 150 of FIG. 1), a sensor 340 (e.g., the sensor module 176 of FIG. 1), an audio processing module 350 (e.g., the audio module 170 of FIG. 1), a power management module 360 (e.g., the power management module 188 of FIG. 1), a battery 370 (e.g., the battery 189 of FIG. 1), an interface 380 (e.g., the interface 177 of FIG. 1), and memory 390 (e.g., the memory 130 of FIG. 1).

According to an embodiment, the communication circuitry 320 may include at least one of a wireless communication module (e.g., a Bluetooth communication module, a cellular communication module, a wireless-fidelity (Wi-Fi) communication module, a near-field communication (NFC) communication module, or a global navigation satellite system (GNSS) communication module) or a wired communication module (e.g., a local area network (LAN) communication module or a power line communication (PLC) communication module). As an example, the Bluetooth communication module may support at least one communication connection (e.g., communication link) by Bluetooth legacy communication and/or Bluetooth low energy (BLE) communication.

The communication circuitry 320 may directly or indirectly communicate with at least one of the external electronic device 101 (e.g., a smartphone), the external electronic device 250 (e.g., a charging device, such as a cradle), or the second electronic device 204 (e.g., the secondary earbud) through a first network (e.g., the first network 198 of FIG. 1), using at least one communication module. The second electronic device 204 may be configured in pair with the first electronic device 202. The communication module 320 may include one or more communication processors that are operable independently from the processor 310 and supports wired or wireless communication.

According to an embodiment, the communication circuitry 320 may be connected, directly or indirectly, with one or more antennas for transmitting signals or information to another electronic device (e.g., the external electronic device 101, the source electronic device 204, or the external electronic device 250) (e.g., a cradle device) or receiving signals or information from the other electronic device. According to an embodiment, at least one antenna appropriate for a communication scheme used in a communication network, such as the first network (e.g., the first network 198 of FIG. 1) or the second network (e.g., the second network 199 of FIG. 2), may be selected from the plurality of antennas by, e.g., the communication circuitry 320. The signal or information may then be transmitted or received between the communication circuitry 320 and another electronic device via the selected at least one antenna.

According to an embodiment, the input device 330 may be configured to generate various input signals that may be used for operation of the first electronic device 202. The input device 330 may include at least one of a touch pad, a touch panel, or a button.

According to an embodiment, the input device 330 may generate a user input regarding the turn-on/off of the first electronic device 202. According to an embodiment, the input device 330 may receive a user input for a communication connection between the first electronic device 202 and the second electronic device 204. According to an embodiment, the input device 330 may receive a user input associated with audio data (or audio content). For example, the user input may be associated with functions of starting playback of audio data, pausing playback, stopping playback, adjusting playback speed, adjusting playback volume, or muting.

According to an embodiment, the sensor 340 may measure or identify the position or operational state of the first electronic device 202. The sensor 340 may convert measured or identified information into an electric signal. The sensor 340 may include at least one of, e.g., a magnetic sensor, an acceleration sensor, a gyro sensor, a geomagnetic sensor, a proximity sensor, a gesture sensor, a grip sensor, a biometric sensor, or an optical sensor.

According to an embodiment, the processor 310 may detect data (e.g., audio data) from the data packets received from the external electronic device 101 and may process the detected data through the audio processing module 350 and output it to the speaker 354. The audio processing module 350 may support an audio data gathering function and reproduce the gathered audio data. Each ding to or embodiment, the processor 310 may detect data (e.g., audio data) from the data packets rece, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the audio processing module 350 may include an audio decoder (not shown) and a D/A converter (not shown). The audio decoder may convert audio data stored in the memory 390 or received from the external electronic device 101 through the communication circuitry 320 into a digital audio signal. The D/A converter may convert the digital audio signal converted by the audio decoder into an analog audio signal. According to an embodiment, the audio decoder may convert audio data received from the external electronic device 101 through the communication circuitry 320 and stored in the memory 390 into a digital audio signal. The speaker 354 may output the analog audio signal converted by the D/A converter.

According to an embodiment, the audio processing module 350 may include an A/D converter (not shown). The A/D converter may convert the analog audio signal transferred through the microphone 352 (hereinafter, referred to as a mic) into a digital voice signal. The mic 352 may include at least one air conduction microphone and/or at least one bone conduction microphone for detecting voice and/or sound.

According to an embodiment, the audio processing module 350 may play various audio data set in the operation of the first electronic device 202. For example, the processor 310 may be designed to detect insertion or removal of the first electronic device 202 into/from the user's ear through the sensor 340 and reproduce audio data regarding an effect sound or guide sound through the audio processing module 350. The output of the sound effect or guide sound may be omitted according to the user setting or the designer's intention.

According to an embodiment, the memory 390 may store various data used by at least one component (e.g., the processor 310 or a sensor 340) of the first electronic device 202. The various data may include, for example, software and input data or output data for a command related thereto. The memory 390 may include a volatile memory or a non-volatile memory.

According to an embodiment, the power management module 360 may manage power supplied to the first electronic device 202. According to an embodiment, the power management module 360 may be implemented as at least part of, for example, a power management integrated circuit (PMIC). According to an embodiment, the power management module 360 may include a battery charging module. According to an embodiment, if another electronic device (e.g., one of the external electronic device 101, the second electronic device 204, or another electronic device) is electrically connected, directly or indirectly, with the first electronic device 202 (wirelessly or wiredly), the power management module 360 may receive power from the other electronic device to charge the battery 370.

According to an embodiment, the battery 370 may supply power to at least one component of the first electronic device 202. The battery 370 may include, e.g., a rechargeable battery. According to an embodiment, if the first electronic device 202 is mounted in the cradle device (e.g., the third electronic device 250), the first electronic device 202 may charge the battery 370 to a designated charging level and then power on the first electronic device 202 or turn on at least a portion of the communication circuitry 320.

According to an embodiment, the interface 380 may support one or more designated protocols that may be used for the first electronic device 202 to directly (e.g., wiredly) connect to the external electronic device 101, the second electronic device 204, the cradle device (e.g., the external electronic device 250) or another electronic device. The interface 380 may include at least one of, e.g., a high definition multimedia interface (HDMI), a USB interface, an SD card interface, a power line communication (PLC) interface, or an audio interface. According to an embodiment, the interface 380 may include at least one connection port for establishing a physical connection with the cradle device (e.g., the external electronic device 250).

According to an embodiment, the processor 310 may execute software to control at least one other component (e.g., a hardware or software component) of the first electronic device 202 connected, directly or indirectly, with the processor 310 and may perform various data processing or computations. According to an embodiment, as at least part of the data processing or computation, the processor 310 may load a command or data received from another component (e.g., the sensor 340 or communication circuitry 320) onto a volatile memory 390, process the command or the data stored in the volatile memory 390, and store resulting data in a non-volatile memory.

According to an embodiment, the processor 310 may establish a communication connection with the external electronic device 101 through the communication circuitry 320 and receive data (e.g., audio data) from the electronic device 101 through the established communication connection. According to an embodiment, the processor 310 may transmit the data, received from the external electronic device 101 through the communication circuitry 320, to the second electronic device 204. According to an embodiment, the processor 310 may perform the operations of the first electronic device 202 which are to be described below. According to an embodiment, the processor 310 may include a physical layer, a link layer, a host, and an application layer for performing Bluetooth communication.

According to various example embodiments, the first electronic device 202 may further include various modules depending on the form in which it is provided. There are many variations according to the convergence trend of digital devices, so it is not possible to list them all, but components equivalent to the above-mentioned components may be further included in the first electronic device 202. Further, it is apparent that in the first electronic device 202 according to various embodiments, specific components may be excluded from the above components or replaced with other components according to the form in which it is provided. This will be easily understood by those of ordinary skill in the art.

According to various embodiments, the second electronic device 204 configured in pair with the first electronic device 202 may include the same or similar components as those included in the first electronic device 202 and may perform all or some of the operations of the first electronic device 202 described below in connection with the drawings.

In an embodiment, the external electronic device 101 may discover at least one of the electronic devices 202 and 204 through a BLE scan and establish a BLE connection with the discovered device. At least one of the electronic devices 202 and 204 may perform BLE advertising to be discovered by the external electronic device 101 and establish a BLE connection with the external electronic device 101.

An electronic device (e.g., the external electronic device 101, the first electronic device 202, or the second electronic device 204) having a Bluetooth core version of 5.2 or higher may support an audio service through a connected isochronous stream (CIS) scheme and/or a broadcast isochronous stream (BIS).

BIS logical transmission (or logical transport) may be used to transmit one or more isochronous data streams to all devices for BIS within a designated range. The BIS may include one or more subevents for transmitting isochronous data packets (e.g., BIS data packets) of the audio stream. The BIS may support transmission of several new isochronous data packets in all BIS events. The BIS does not include an acknowledgment protocol, and may be transmitted unidirectionally from a broadcasting device (e.g., the source electronic device) that broadcasts traffic. To enhance reliability of BIS logical transmission, isochronous data packets may be unconditionally retransmitted by increasing the number of subevents in all events. Transmission reliability may be enhanced by transmitting the isochronous data packets at an interval preceding an interval related to the isochronous data packets. This is referred to as pre-transmission. The BIS may be identified by a unique access address and timing information. The access address and timing information may be transmitted through a packet transmitted using a corresponding periodic advertising broadcast logic transmission.

A scanning device (e.g., a sink electronic device) supporting a synchronized receiver role (e.g., a sink role) may receive isochronous data (e.g., isochronous data packets) from the BIS after synchronizing with the BIS using the timing information obtained from periodic advertising packets.

Each BIS may be part of a broadcast isochronous group (BIG). The BIG may include two or more BISs having the same isochronous interval (e.g., ISO_Interval). BISs in the BIG have a common timing reference based on the source electronic device, and may be temporally synchronized with each other. The maximum number of BISs in the BIG may have a designated value (e.g., 31). BIG may also include control subevents.

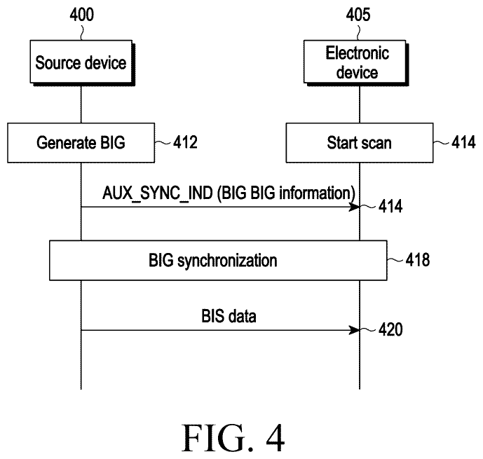

FIG. 4 is a signal flowchart (sequence diagram) illustrating a procedure for synchronizing with a broadcast isochronous group (BIG), according to an embodiment.

Referring to FIG. 4, in operation 412, the source electronic device 400 may generate a BIG including one or more BISs and may start periodic advertising related to the BIG. In operation 414, for reception synchronization, the electronic device 405 (e.g., the external electronic device 101, the first electronic device 202, or the second electronic device 204) may start BLE scanning.

In operation 416, the source electronic device 400 may periodically transmit an advertising packet (e.g., AUX_SYNC_IND) related to the BIG at a designated interval. For example, AUX_SYNC_IND may include BIS information in an additional controller advertising data (ACAD) field. The BIG information may include parameters used to synchronize with the BIS provided by the source electronic device 400. The electronic device 405 may receive the advertising packet through the BLE scanning and obtain BIG information (e.g., the BIG information 500) from the advertising packet.

In operation 418, the electronic device 405 may synchronize with the BIG provided by the source electronic device 400 using parameters included in the BIG information. In an embodiment, the BIG synchronization operation performed by the electronic device 405 may include an operation of calculating an access address and timing information at which audio data is transmitted, based on the BIG information. In an embodiment, the timing information may include channel information (e.g., a channel map) and transmission time points of audio data.

In operation 420, the electronic device 405 may receive audio data (e.g., at least one BIS data packet) broadcast by the source electronic device 400 through at least one BIS in the BIG.

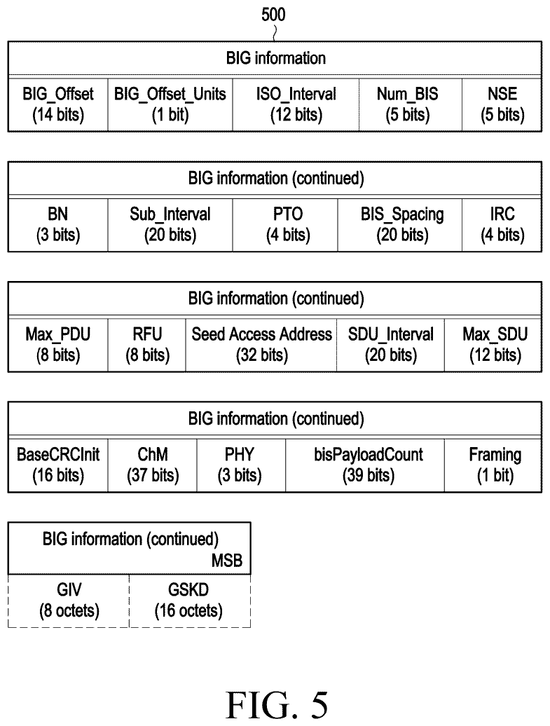

FIG. 5 is a view illustrating a format of BIG information according to an embodiment.

Referring to FIG. 5, the BIG information 500 may include at least one of BIG_Offset, BIG_Offset_units, ISO_Interval, Num_BIS, number of subevent (NSE), burst number (BN), Sub_Interval, pre-transmission offset (PTO), BIS_Spacing, immediate repetition count (IRC), Max_PDU, reserved for future use (RFU), SeedAccessAddress, SDU_Interval, Max_SDU, BaseCRCInit, channel map (ChM), physical (PHY), bisPayloadCount, Framing, group initialization vector (GIV), or group session key derivation (GSKD). In an embodiment, the length of the BIG information 500 may be 33 octets when not encrypted, and 57 octets when encrypted.

Parameters that may be included in the BIG information 500 will be described below.

Num_BIS indicates the number of BISs in the BIG. Each of the BISs in the BIG may be assigned a different BIS_Number from 1 to Num_BIS.

ISO_Interval may indicate a time of 1.25 ms between two adjacent BIG anchor points. (5 ms to 4s)

BIS_Spacing may indicate the time between the start time of the subevents in adjacent BISs in the BIG and the start time of the first subevent of the last BIS.

Sub_Interval may indicate the time between start times of two consecutive subevents of each BIS.

Max_PDU is the maximum number of data octets capable of transmitting each BIS data packet within the BIG and may indicate the maximum duration of the packet. (1 to 251 octets)

Max_SDU may indicate the maximum size (e.g., maximum duration) of the service data unit (SDU) in the BIG. (1 to 4095 octets)

BN, PTO, and IRC may include values for controlling which data is transmitted in each BIG event. Subevents of each BIS event may be divided into groups including BN subevents. Thus, the group count (GC)) is NSE/BN. IRC may designate the number of groups carrying data related to the current BIS event. The remaining groups may carry data related to future BIS events designated by the PTO.

The NSE indicates the maximum number of subevents within each BIG event.

The framing field may indicate whether the BIG transmits framed data or unframed data.

BIG_Offset may indicate the time from the start time of the packet (e.g., AUX_SYNC_IND) including the BIG information 500 to the next BIG anchor point. The value of BIG_Offset may be indicated in units indicated by bits of BIG_Offset_Units. The time offset is determined by multiplying the value of BIG_Offset by the unit indicated by BIG_Offset_Units. The time offset may be greater than 600 μs (micro second). When the bit of BIG_Offset_Units is set, the unit is 300 μs, otherwise 30 μs. The bit of BIG_Offset_Units may not be set if the time offset is less than 491,460 μs. The BIG anchor point may be between the time offset and the time offset plus 1 unit after the start time of the packet (e.g., AUX_SYNC_IND) as follows.

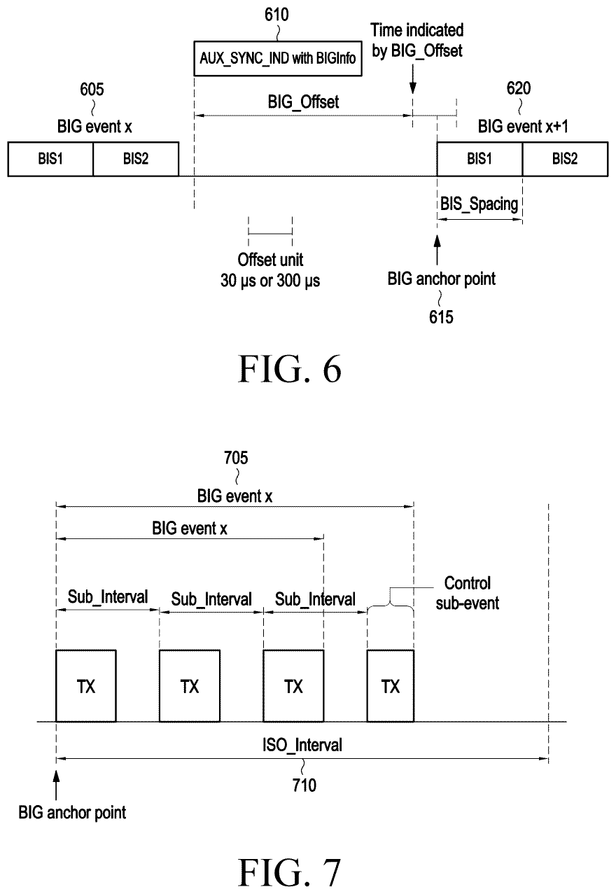

FIG. 6 is a view illustrating a BIG event for a periodic advertising event according to an embodiment.

Referring to FIG. 6, each BIS in the BIG provided by the source electronic device 400 may be configured as a schedule of a time slot known as an event and a subevent. The source electronic device 400 may transmit BIS data packets in subevents (e.g., a BIS1 subevent and a BIS2 subevent) within a BIG event (e.g., a BIG event x 605).

The source electronic device 400 may transmit an advertising packet 610 (e.g., AUX_SYNC_IND with BIGInfo) including BIG information (e.g., BIG information 500) at a designated time point. The electronic device 405 may determine the start time of the BIG anchor point 615 after the start time of the AUX_SYNC_IND based on the BIG_Offset and the BIG_Offset_Units included in the BIG information 500. A next BIG event (e.g., BIG event x+1 620) may start from the BIG anchor point 615, and each BIS subevent (e.g., BIS1 subevent or BIS2 subevent) may have a duration defined by for example BIS_Spacing.

SeedAccessAddress may indicate the seed access address for BIG.

SDU_Interval may indicate the time interval of the SDU.

BaseCRCInit may include the cyclic redundancy check (CRC) initial value for the BIS data packet.

ChM may include a channel map indicating a used data channel and an unused data channel.

PHY may indicate the physical channel transmission scheme (e.g., the symbol per second and/or the coding scheme) used by the BIG.

bisPayloadCount may include a count value for detecting the missing payload. bisPayloadCount may include a value for the first subevent of the BIG event based on BIG_Offset.

When the BIG is encrypted, the GIV and GSKD may include values for describing encryption.

The parameters included in the BIG information 500 may not be changed during the lifetime of the BIG.

FIG. 7 is a view illustrating a BIG and BIS events according to an embodiment.

Referring to FIG. 7, a BIG event (e.g., the BIG event x 705) may include one or more BIS data packets (e.g., protocol data units (PDUs)). The source electronic device 400 may transmit BIS data packets in BIG events (e.g., BIG event x 705). Each BIG event (e.g., BIG event x 705) may be divided into Num_BIS BIS events and, if present, one control subevent. Each BIS event may be divided into NSE subevents.

Each BIS event may start at the BIS anchor point and end after the last subevent. Each BIG event (e.g., the BIG event x 705) may start at the BIG anchor point and, if there is a control subevent, it may end thereafter, otherwise, end at the last constituent BIS event. The BIG anchor points may be regularly spaced apart by an interval of ISO_Interval 710. The BIS anchor points for BIS n of the BIG may be after (n−1)×BIS_Spacing from the BIG anchor points, and may be regularly spaced apart by ISO_Interval 710. The subevents of each BIS may be spaced apart by Sub_Interval. The source electronic device 400 may terminate the current BIG event (e.g., the BIG event x 705), at least T_IFS (time for inter frame space) before the BIG anchor point of the next BIG event.

BISs in the BIG may be arranged sequentially or interleaved according to Sub_Interval and BIS_Spacing. In the case of sequential arrangement, BIS_Spacing may be greater than or equal to NSE X Sub_Interval, and all subevents of the BIS event may occur together. When interleaved, Sub_Interval may be Num_BIS X BIS_Spacing, the first subevents of all BISs may be adjacent, and the second subevents of all the following BISs may be adjacent.

The maximum length possible for the data portion (except for the control subevent) of the BIG event may be represented as BIG_Sync_Delay. The value of BIG_Sync_Delay may be the same as the time from the BIS anchor point to the BIG synchronization point, which is the end point of the packet including the payload of the Max_PDU octet transmitted in the last subevent. (BIG_Sync_Delay=(Num_BIS−1)×BIS_Spacing+(NSE−1)×Sub_Interval+MPT)

The BIS subevent is an opportunity for the source electronic device 400 to transmit BIS data packets and for the sink electronic device 405 (e.g., the electronic device 202 or the electronic device 204) to receive the BIS data packets. The source electronic device 400 may transmit one BIS data packet at a time point at which each BIS subevent of the BIS event starts, and may transmit at least one BIS packet within six consecutive BIS events.

For each BIS event, the source electronic device 400 may provide a data burst including BN payloads. Each payload may include a single fragment or one or more SDU segments. One data burst is related to a designated BIS event, but may be transmitted in earlier events.

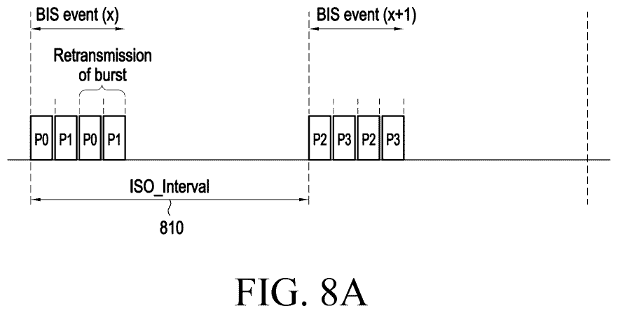

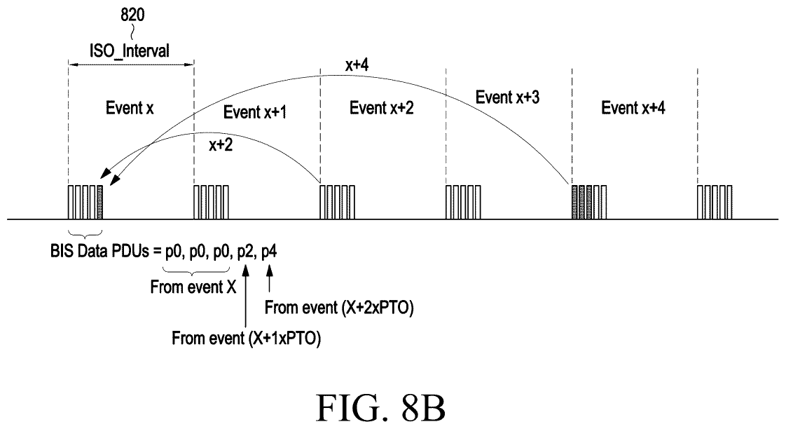

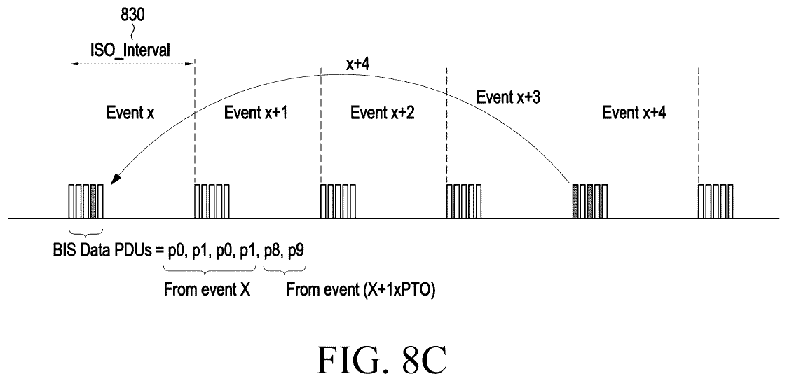

FIGS. 8A, 8B, and 8C are views illustrating retransmission of BIS data packets according to an embodiment.

Referring to FIG. 8A, payloads may be allocated to BIS sub-events in each BIS event in a BIS having BN=2, IRC=2, PTO=0, and NSE=4. One BIS event corresponding to ISO_Interval 810 may include up to NSE(=4) BIS sub-events. BIS data packets (e.g., P0, P1, or P2, P3) each including two payloads in each BIS event (e.g., BIS event x or BIS event x+1) may be allocated to two preceding BIS sub-events, and the remaining sub-events may be used for retransmission of the same BIS data packets (e.g., P0, P1, or P2, P3).

Referring to FIG. 8B, payloads may be allocated to BIS sub-events in each BIS event in a BIS having BN=1, IRC=3, PTO=2, and NSE=5. One BIS event corresponding to ISO_Interval 820 may include up to NSE(=5) BIS sub-events. Within the BIS event x, the BIS data packet p0 may be transmitted in three preceding BIS sub-events, the BIS data packet p2 for the BIS event x+2 may be transmitted in the fourth BIS sub-event, and the BIS data packet p4 for the BIS event x+4 may be transmitted in the last BIS sub-event. Accordingly, the BIS data packet p2 may be repeatedly transmitted in the BIS event x and the BIS event x+2, and the BIS data packet p4 may be repeatedly transmitted in the BIS event x and the BIS event x+4.

Referring to FIG. 8C, payloads may be allocated to BIS sub-events in each BIS event in a BIS having BN=2, IRC=2, PTO=4, and NSE=6. One BIS event corresponding to ISO_Interval 830 may include up to NSE(=6) BIS sub-events. Within the BIS event x, the BIS data packets p0 and p1 may be transmitted in four previous BIS sub-events, and in the last two BIS sub-events, the BIS data packets p8 and p9 for the BIS event x+4 may be transmitted. Accordingly, the BIS data packets p8 and p9 may be repeatedly transmitted in the BIS event x and the BIS event x+4.

As shown in FIGS. 8A, 8B, and 8C, the source electronic device 400 may perform repeated and mandatory retransmissions to secure transmission reliability. However, due to physical distance, physical interference, or wireless interference between the source electronic device 400 and the electronic device 405 (e.g., the electronic device 202 or electronic device 204), the electronic device 405 may not instantaneously receive audio data (e.g., at least one BIS data packet) transmitted by the source electronic device 400 according to a designated retransmission protocol, resulting in audio missing.

Since the BIS does not have an acknowledgement protocol, it may be difficult to guarantee transmission reliability. In order to enhance transmission reliability, the source electronic device 400 may mandatorily retransmit BIS data packets including the same payload a designated number of times, but this may waste resources that may be used for other communications (e.g., Wi-Fi coexistence (COEX) or Bluetooth (BT) concurrency).

Mandatory retransmission of the source electronic device 400 may be a great disadvantage in current consumption. Further, since there is no acknowledgment protocol, the source electronic device 400 may not properly respond to the surrounding communication environment, so that it should maintain a fixed bit rate, which may cause disadvantages in the transmission rate.

Various example embodiments may be related to electronic devices operating in the same frequency band (e.g., 2.4 GHz), such as Bluetooth (Bluetooth classic or BLE) or Wi-Fi. An electronic device (e.g., the electronic device 405) configured to operate as a BIS sink may transmit, to another sink electronic device, reception indication information indicating the reception state of audio data (e.g., at least one BIS data packet) broadcast by the source electronic device 400. The other sink electronic device may transfer the corresponding audio data to the electronic device 405 based on the reception indication information.

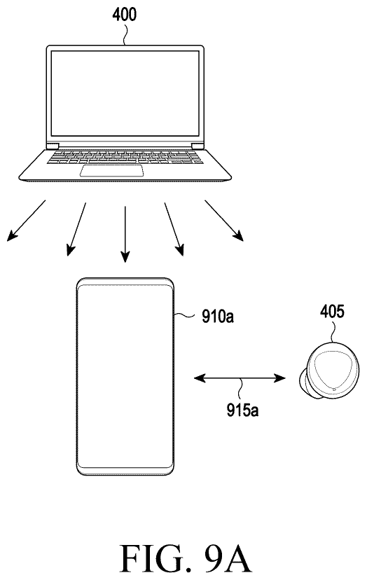

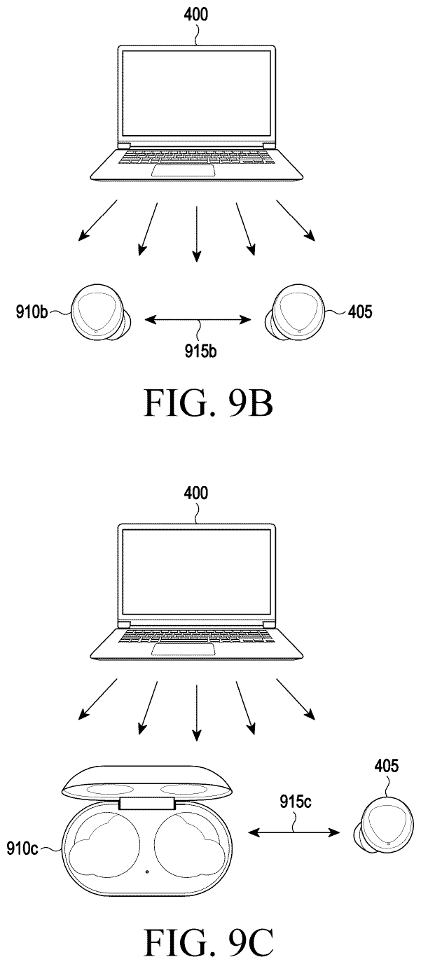

FIGS. 9A, 9B, and 9C are views illustrating a system structure transmitting audio data according to various example embodiments.

Referring to FIG. 9A, the source electronic device 400 may perform a broadcast audio service according to the user's intention or a designated policy. The source electronic device 400 may generate a BIG including one or more BISs for the broadcast audio service, periodically advertise connection information (e.g., BIG information 500) related to the generated BIG, and transmit (e.g., broadcast) audio data through BISs in the BIG based on the BIG information.

The electronic device 405 configured to operate as a BIS sink may include, e.g., an electronic device 202 or an electronic device 204 constituting an ear wearable device (e.g., an earbud). When the electronic device 405 is an earbud (e.g., the electronic device 202), the electronic device 405 may obtain the BIG information or receive synchronization information necessary to obtain the BIG information from the external electronic device 910a. In an embodiment, the electronic device 405 may directly receive the BIG information from the server 400 (e.g., without passing through the external electronic device 910a). In an embodiment, the external electronic device 910a may be a parent device (e.g., a smartphone or an electronic device 101) to which the electronic device 405 (e.g., the electronic device 202) is paired and/or bonded.

In an embodiment, the external electronic device 910a operating as an assistant BIS role for the electronic device 405 may perform a BLE scan and receive synchronization information necessary for receiving BIG information through periodic advertising broadcast from the source electronic device 400 that is to receive an audio service by the electronic device 405. The external electronic device 910a may transmit the synchronization information to the electronic device 405. The electronic device 405 may receive BIG information from the source electronic device 400 based on the synchronization information.

The electronic device 405 may calculate parameters such as an access address, channel information, and transmission times (opportunities) where audio data is transmitted based on the BIG information, and may be synchronized with the BIG of the source electronic device 400 using the parameters and receive audio data broadcasted from the source electronic device 400 through BISs in the BIG.

The electronic device 202 may connect a communication link 915a (e.g., Bluetooth connection or BLE connection) with the external electronic device 910a. In an embodiment, the electronic device 405 may receive audio data (e.g., at least one BIS data packet) and transmit reception indication information related to the audio data to the external electronic device 910a through the communication link 915a. In an embodiment, the reception indication information may include at least one of reception identification information (data received indicator) indicating that at least one BIS data packet has been successfully received or a non-reception identification information (data missing indicator) indicating that at least one BIS data packet is missing.

The external electronic device 910a may operate as a BIS sink for the source electronic device 400 for backing up the audio service for the electronic device 405. In an embodiment, the external electronic device 910a may be synchronized with the BIG of the source electronic device 400 based on the BIG information and receive audio data through BISs in the BIG. In an embodiment, the external electronic device 910a may receive the same or at least some audio data as that received by the electronic device 405.

The external electronic device 910a may determine whether reception indication information (e.g., reception identification information or non-reception identification information) is received from the electronic device 405 every designated period (or a designated number of BIS data packet(s)). In an embodiment, when the reception identification information is not received from the electronic device 202, the external electronic device 910a may transmit (relay) audio data (e.g., at least one BIS data packet) corresponding to the non-reception identification information not received. In an embodiment, when the non-reception identification information is received from the electronic device 202, the external electronic device 910a may transmit (e.g., relay) the audio data (e.g., at least one BIS data packet) corresponding to the non-reception identification information to the electronic device 202.

The electronic device 202 may output audio by combining audio data received from the source electronic device 400 and audio data received from the external electronic device 910a.

Referring to FIG. 9B, the source electronic device 400 may periodically advertise connection information (e.g., BIG information 500) related to the BIG for the broadcast audio service, and transmit (e.g., broadcast) audio data through BISs in the BIG based on the BIG information.

The electronic device 405 configured to operate as a BIS sink may include, e.g., an electronic device 202 constituting an ear wearable device (e.g., an earbud). In an embodiment, the electronic device 405 may directly receive BIG information broadcasted from the source electronic device 400 or may receive it from an external electronic device (e.g., a parent device). The electronic device 405 may be synchronized with the BIG of the source electronic device 400 based on the BIG information and receive audio data broadcast from the source electronic device 400 through BISs in the BIG.

The electronic device 202 may connect a communication link 915b (e.g., Bluetooth connection or BLE connection) with the external electronic device 910b. In an embodiment, the electronic device 405 may receive audio data (e.g., at least one BIS data packet) and transmit reception indication information related to the audio data to the external electronic device 910b through the communication link 915b. In an embodiment, the reception indication information may include at least one of reception identification information and non-reception identification information.

In an embodiment, the electronic device 405 may be a first earbud (e.g., a left earbud or the electronic device 202), and the external electronic device 910b may be a second earbud (e.g., a right earbud or the electronic device 204). In an embodiment, the external electronic device 910b may directly receive BIG information broadcast from the source electronic device 400 or may receive BIG information from an external electronic device (e.g., a parent device). The external electronic device 910b may be synchronized with the BIG of the source electronic device 400 based on the BIG information and receive audio data through the BISs in the BIG. In an embodiment, the external electronic device 910b may receive the same as or at least a portion of the audio data received by the electronic device 405.

The external electronic device 910b may determine whether reception indication information (e.g., reception identification information or non-reception identification information) is received from the electronic device 405 every designated period (or a designated number of BIS data packet(s)). In an embodiment, when the reception identification information is not received from the electronic device 202, the external electronic device 910b may transmit (e.g., relay) the audio data (e.g., at least one BIS data packet) corresponding to the non-received reception identification information to the electronic device 202. In an embodiment, when the non-reception identification information is received from the electronic device 202, the external electronic device 910a may transmit (e.g., relay) the audio data (e.g., at least one BIS data packet) corresponding to the non-reception identification information to the electronic device 202.

The electronic device 202 may output audio by combining audio data received from the source electronic device 400 and audio data received from the external electronic device 910b.

Referring to FIG. 9C, the source electronic device 400 may periodically advertise connection information (e.g., BIG information 500) related to the BIG for the broadcast audio service, and transmit (e.g., broadcast) audio data through BISs in the BIG based on the BIG information.

The electronic device 405 configured to operate as a BIS sink may include, e.g., an electronic device 202 constituting an ear wearable device (e.g., an earbud). In an embodiment, the electronic device 405 may directly receive BIG information broadcasted from the source electronic device 400 or may receive it from an external electronic device (e.g., a parent device). The electronic device 405 may be synchronized with the BIG of the source electronic device 400 based on the BIG information and receive audio data broadcast from the source electronic device 400 through BISs in the BIG.

The electronic device 202 may connect a communication link 915c (e.g., Bluetooth connection or BLE connection) with the external electronic device 910c. In an embodiment, the electronic device 405 may receive audio data (e.g., at least one BIS data packet) and transmit reception indication information related to the audio data to the external electronic device 910c. In an embodiment, the reception indication information may include at least one of reception identification information and non-reception identification information.

In an embodiment, the electronic device 405 may be an earbud (e.g., a left earbud or the electronic device 202), and the external electronic device 910c may be a cradle device 250 configured to receive the earbud. In an embodiment, the external electronic device 910c may directly receive BIG information broadcast from the source electronic device 400 or may receive BIG information from an external electronic device (e.g., a parent device). The external electronic device 910c may be synchronized with the BIG of the source electronic device 400 based on the BIG information and receive audio data through the BISs in the BIG. In an embodiment, the external electronic device 910c may receive the same as or at least a portion of the audio data received by the electronic device 405.

The external electronic device 910c may determine whether reception indication information (e.g., reception identification information or non-reception identification information) is received from the electronic device 405 every designated period (or a designated number of BIS data packet(s)). In an embodiment, when the reception identification information is not received from the electronic device 202, the external electronic device 910c may transmit (e.g., relay) the audio data (e.g., at least one BIS data packet) corresponding to the non-received reception identification information to the electronic device 202. In an embodiment, when the non-reception identification information is received from the electronic device 202, the external electronic device 910a may transmit (e.g., relay) the audio data (e.g., at least one BIS data packet) corresponding to the non-reception identification information to the electronic device 202.

The electronic device 202 may output audio by combining audio data received from the source electronic device 400 and audio data received from the external electronic device 910c.

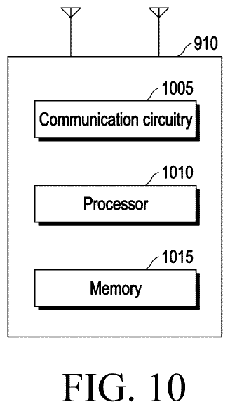

FIG. 10 is a view illustrating a configuration of an external electronic device relaying audio data according to an embodiment. In an embodiment, the external electronic device 910 may include an external electronic device 910a, an external electronic device 910b, or an external electronic device 910c.

Referring to FIG. 10, the external electronic device 910 may include the same or similar components to at least one of the components (e.g., modules) of the external electronic device 101 illustrated in FIG. 1. The external electronic device 910 may include communication circuitry 1005 (e.g., the communication module 190 of FIG. 1, comprising communication circuitry), a processor 1010 (e.g., the processor 120 of FIG. 1, comprising processing circuitry), and memory 390 (e.g., the memory 130 of FIG. 1).

The communication circuitry 1005 may include at least one of a wireless communication module (e.g., a Bluetooth communication module, a cellular communication module, a wireless-fidelity (Wi-Fi) communication module, a near-field communication (NFC) communication module, or a global navigation satellite system (GNSS) communication module) or a wired communication module (e.g., a local area network (LAN) communication module or a power line communication (PLC) communication module). As an example, the Bluetooth communication module may support at least one communication connection (e.g., communication link) by Bluetooth legacy communication and/or Bluetooth low energy (BLE) communication.

The communication circuitry 1005 may directly or indirectly communicate with at least one of the source electronic device 400, the electronic device 405, or the external electronic device (e.g., a parent device) using at least one communication module included therein. The communication module 1005 may include at least one processor that is operable independently from the processor 310 and supports wired or wireless communication.

The communication circuitry 1005 may be connected, directly or indirectly, with one or more antennas for transmitting signals or information to another electronic device (e.g., the source electronic device 400 or the electronic device 405) or receiving signals or information from the other electronic device. The signal or information may then be transmitted or received between the communication circuitry 1005 and another electronic device via at least one antenna.

The processor 1010 may receive data packets (e.g., BIS data packets) including audio data from the source electronic device 400 through the communication circuitry 1005. The processor 1010 may receive reception indication information corresponding to the audio data (e.g., at least one BIS data packet) from the electronic device 405 through the communication circuitry 1005. The processor 1010 may transmit at least one BIS data packet received from the source electronic device 400 to the electronic device 405 through the communication circuitry 1005 based on the reception indication information.

According to an embodiment, the memory 1015 may store various data used by at least one component (e.g., the processor 1010 or communication circuitry 1005) of the external electronic device 910. The various data may include, for example, software and input data or output data for a command related thereto. The memory 1015 may include a volatile memory and/or a non-volatile memory.

According to an embodiment, the processor 1010 may execute software to control at least one other component (e.g., a hardware or software component) of the external electronic device 910 connected with the processor 1010 and may perform various data processing or computations. According to an embodiment, as at least part of the data processing or computation, the processor 1010 may load a command or data received from another component (e.g., the communication circuitry 1005) in the memory 1015, process the command or the data stored in the memory 1015, and store resulting data in the memory 1015.

According to an embodiment, the processor 1010 may establish a communication connection with the source electronic device 400 through the communication circuitry 1005 and receive data (e.g., audio data) from the electronic device 400 through the established communication connection. According to an embodiment, the processor 1010 may establish a communication connection with the electronic device 405 through the communication circuitry 1005 and receive or transmit information and data from/to the electronic device 405 through the established communication connection. The processor 1005 may perform the operations of the external electronic device 910 which are to be described below. According to an embodiment, the processor 1010 may include at least one of a physical layer, a link layer, a host, or an application layer for performing Bluetooth communication.

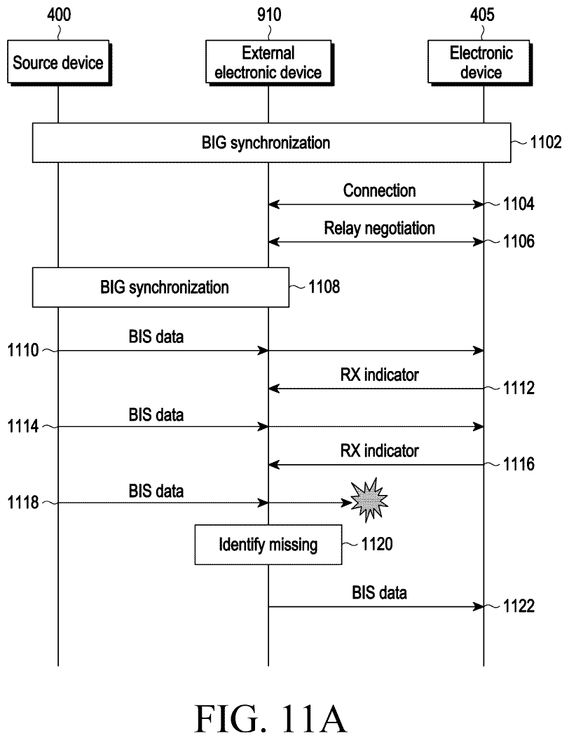

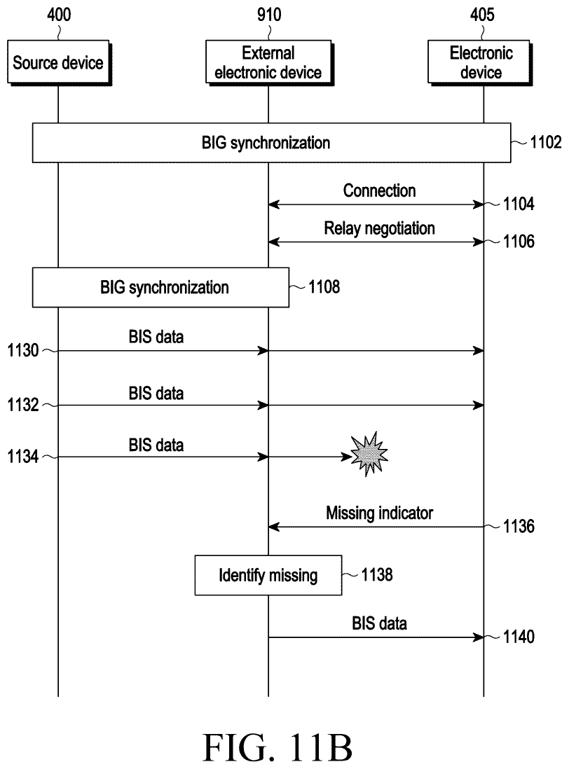

FIGS. 11A and 11B are signal flowcharts illustrating a procedure of sharing a reception state between sink electronic devices according to an embodiment. According to embodiments, at least one of operations to be described below may be omitted, modified, or reordered.

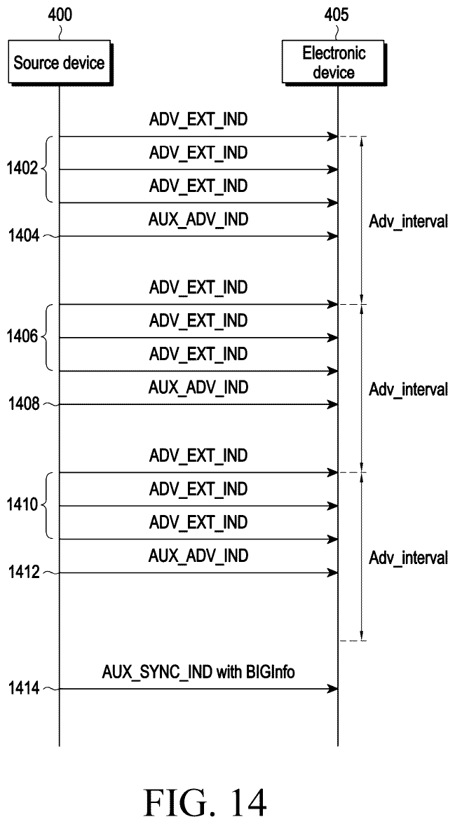

Referring to FIG. 11A, in operation 1102, the electronic device 405 may be synchronized with the BIG of the source electronic device 400 based on connection information (e.g., BIG information 500) broadcast from the source electronic device 400 through periodic advertising (e.g., see FIG. 14). In an embodiment, the electronic device 405 may calculate an access address and timing information through which audio data is transmitted based on the BIG information. When the electronic device 405 is an earbud (e.g., the electronic device 202), the electronic device 405 may obtain the BIG information through an external electronic device (e.g., the electronic device 910a).

In operation 1104, the electronic device 405 may establish a communication link (e.g., the communication link 915a, the communication link 915b, or the communication link 915c) that may be used to synchronize the reception state of audio data with the external electronic device 910. In an embodiment, the external electronic device 910 may include a parent device (e.g., the external electronic device 910a), another earbud (e.g., the external electronic device 910b), or a cradle device (e.g., the external electronic device 910c). When the electronic device 405 is bonded to the external electronic device 910, or a communication link connected to the external electronic device 910 already is present, operation 1104 may be omitted. In operation 1106, the electronic device 405 may perform audio relay negotiation

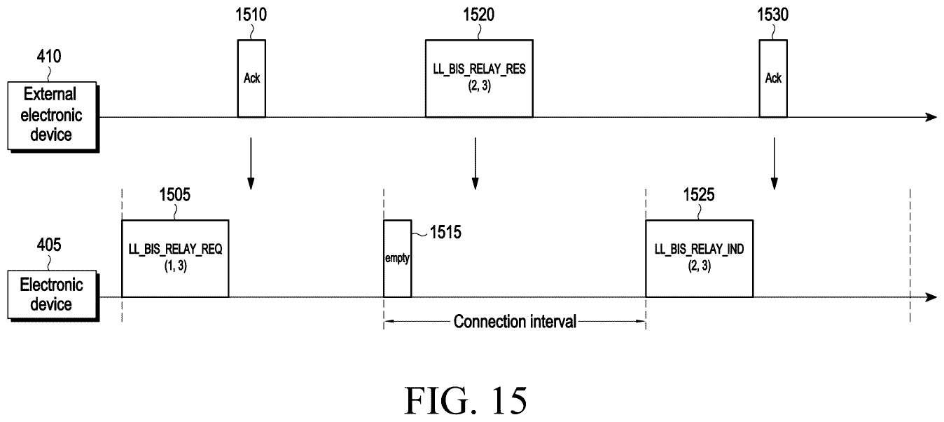

with the external electronic device 910 for transferring (e.g., relay) of missing audio data through the communication link. In an embodiment, operation 1106 may include operations of FIG. 15. In an embodiment, audio relay negotiation may determine at least one of a method of synchronizing the reception state (e.g., use of reception identification information, use of non-reception identification information, use of both reception identification information and non-reception identification information, and/or a period of transferring reception indication information) or a method for transferring missing audio data. When a period for synchronizing the reception state and/or a method of transferring missing audio data is predetermined, operation 1106 may be omitted. In an embodiment, operation 1104 and/or operation 1106 may be performed at any time after a time when the external electronic device 910 and the electronic device 405 are connected and before starting data reception.

In operation 1108, the external electronic device 910 may be synchronized with the BIG of the source electronic device 400 based on the BIG information broadcast from the source electronic device 400 through periodic advertising (e.g., see FIG. 14). In an embodiment, the external electronic device 910 may calculate an access address and timing information where audio data is transmitted based on the BIG information. In an embodiment, operation 1108 may be performed before, simultaneously with, or after at least one of operation 1102, 1104, or 1106.

In operation 1110, the electronic device 405 and the external electronic device 910 may receive audio data (e.g., at least one first BIS data packet) broadcast from the source electronic device 400 through BISs in the BIG synchronized in operations 1102 and 1108. In operation 1112, the electronic device 405 may synchronize the reception state of audio data with the external electronic device 910 by transmitting the first reception identification information for indicating that the at least one first BIS data packet has been successfully received.

In operation 1114, the electronic device 405 and the external electronic device 910 may receive audio data (e.g., at least one second BIS data packet) broadcast from the source electronic device 400 through BISs in the BIG. In operation 1116, the electronic device 405 may transmit second reception identification information for indicating that the at least one second BIS data packet has been successfully received to the external electronic device 910. In an embodiment, operation 1112 may be omitted, and the second reception identification information in operation 1116 may indicate that the at least one first BIS data packet and the at least one second BIS data packet have been successfully received.

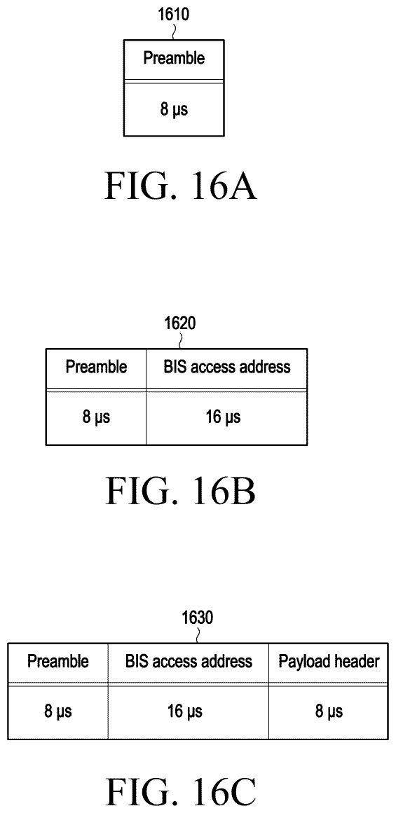

In an embodiment, the electronic device 405 may transmit the first and second reception identification information at a time according to the audio relay negotiation of operation 1106. In an embodiment, at least one of the first and second reception identification information may include the packet of FIG. 16A, 16B, or 16C. In an embodiment, the electronic device 405 may indicate successful reception of the BIS data packet by transmitting (first or second) reception identification information through a time and channel corresponding to (first or second) BIS data packet. In an embodiment, the (first or second) reception identification information may be transmitted using the same channel and the same or different access addresses immediately after the transmission opportunity of the (first or second) BIS data packet.

In operation 1118, the external electronic device 910 receives audio data (e.g., at least one third BIS data packet) broadcast from the source electronic device 400 through BISs in the BIG, but the electronic device 405 may not receive the at least one third BIS data packet. In operation 1120, the external electronic device 910 may identify that the at least one third BIS data packet is missing from the electronic device 405 based on the reception identification information corresponding to the at least one third BIS data packet being not received from the electronic device 405. In an embodiment, the external electronic device 910 may identify that the at least one third BIS data packet is missing from the electronic device 405 based on receiving the non-reception identification information corresponding to the at least one third BIS data packet from the electronic device 405.

In operation 1122, the external electronic device 910 may transmit (e.g., relay) at least one BIS data packet (e.g., at least one third BIS data packet) to the electronic device 405. In an embodiment, the external electronic device 910 may transmit (e.g., relay) the at least one third BIS data packet received from the source electronic device 400 to the electronic device 405 using the same access address or a new access address in operation 1118. In an embodiment, the external electronic device 910 may transmit the at least one third BIS data packet at a time according to the audio relay negotiation of operation 1106. In an embodiment, the external electronic device 910 may transmit only the missing data packet (e.g., at least one third BIS data packet) identified as missing to the electronic device 405 based on identifying data missing (e.g., operation 1120), or transmit data packets for a designated time interval including the data packet identified as missing to the electronic device 405. In an embodiment, the external electronic device 910 may transmit one or more data packets that have not yet been reproduced by the electronic device 405 to the electronic device 405.

In an embodiment, the external electronic device 910 may transmit (e.g., relay) the at least one third BIS data packet received from the source electronic device 400 in operation 1118 to the electronic device 405 using the same channel (e.g., physical channel). The electronic device 405 may receive the at least one third BIS data packet from the external electronic device 910 without channel switching.

The electronic device 405 may output audio through a speaker (e.g., the speaker 354) using audio data obtained from the at least one first BIS data packet, the at least one second BIS data packet, and the at least one third BIS data packet. The electronic device 405 may identify a reproduction time when the corresponding BIS data packet should be output through the speaker 354 based on synchronization delay information (e.g., BIG_sync_delay) included in each BIS data packet, and may reproduce audio data included in the corresponding BIS data packet at the identified reproduction time.

Referring to FIG. 11B, operations 1102, 1104, 1106, and 1108 may be similar to the description in FIG. 11A.

In operation 1130, the electronic device 405 and the external electronic device 910 may receive audio data (e.g., at least one first BIS data packet) broadcast from the source electronic device 400 through BISs in the BIG synchronized in operations 1102 and 1108. In operation 1132, the electronic device 405 and the external electronic device 910 may receive audio data (e.g., at least one second BIS data packet) broadcast from the source electronic device 400 through BISs in the BIG.

In operation 1134, the external electronic device 910 receives audio data (e.g., at least one third BIS data packet) broadcast from the source electronic device 400 through BISs in the BIG, but the electronic device 405 may not receive the at least one third BIS data packet. In operation 1136, the electronic device 405 may transmit non-reception identification information (e.g., missing indicator) related to the at least one third BIS data packet to the external electronic device 910 based on identifying that the at least one third BIS data packet is missing.

In an embodiment, the electronic device 405 may transmit the non-reception identification information at a time according to the audio relay negotiation of operation 1106. In an embodiment, the non-reception identification information may include the packet of FIG. 16A, FIG. 16B, or FIG. 16C. In an embodiment, the electronic device 405 may notify that the third BIS data packet is missing by transmitting the non-reception identification information through a time and channel corresponding to the third BIS data packet. In an embodiment, the non-reception identification information may be transmitted using the same channel or the same or different access addresses immediately after the transmission opportunity of the third BIS data packet.

In operation 1138, the external electronic device 910 may identify that the at least one third BIS data packet is missing from the electronic device 405 based on the non-reception identification information corresponding to the at least one third BIS data packet being received from the electronic device 405.

In operation 1140, the external electronic device 910 may transmit (e.g., relay) at least one third BIS data packet (e.g., at least one third BIS data packet) to the electronic device 405. In an embodiment, the external electronic device 910 may transmit (e.g., relay) the at least one third BIS data packet received from the source electronic device 400 to the electronic device 405 using the same access address or a new access address in operation 1134. In an embodiment, the external electronic device 910 may transmit the at least one third BIS data packet at a time according to the audio relay negotiation of operation 1106. In an embodiment, the external electronic device 910 may transmit only the missing data packet (e.g., at least one third BIS data packet) identified as missing to the electronic device 405 based on identifying data missing (e.g., operation 1138), or transmit data packets for a designated time interval including the data packet identified as missing to the electronic device 405. In an embodiment, the external electronic device 910 may transmit one or more data packets that have not yet been reproduced by the electronic device 405 to the electronic device 405.

In an embodiment, the external electronic device 910 may transmit (e.g., relay) the at least one third BIS data packet received from the source electronic device 400 in operation 1134 to the electronic device 405 using the same channel (e.g., physical channel). The electronic device 405 may receive the at least one third BIS data packet from the external electronic device 910 without channel switching.

The electronic device 405 may output audio through a speaker (e.g., the speaker 354) using audio data obtained from the at least one first BIS data packet, the at least one second BIS data packet, and the at least one third BIS data packet. The electronic device 405 may identify a reproduction time when the corresponding BIS data packet should be output through the speaker 354 based on synchronization delay information (e.g., BIG_sync_delay) included in each BIS data packet, and may reproduce audio data included in the corresponding BIS data packet at the identified reproduction time.

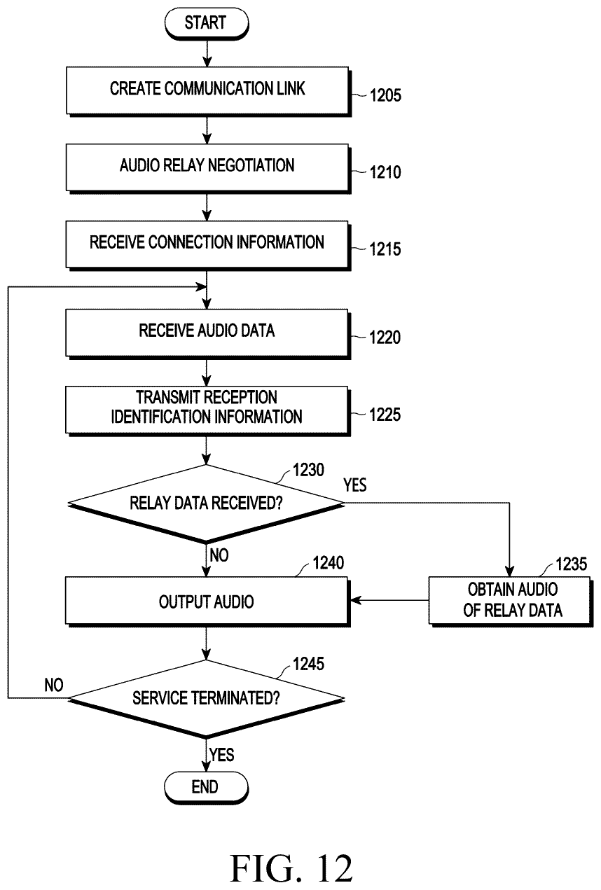

FIG. 12 is a flowchart illustrating an operation of an electronic device 405 transmitting reception indication information according to an embodiment. According to embodiments, at least one of operations to be described below may be omitted, modified, or reordered. In an embodiment, the electronic device 405 is an earbud (e.g., the electronic device 202), and at least one of operations to be described below may be executed by the processor (e.g., the processor 310) of the electronic device 405.

Referring to FIG. 12, in operation 1205, the electronic device 405 (e.g., the processor 310) may create a communication link (e.g., the communication link 915a, the communication link 915b, or the communication link 915c) with the external electronic device 910 (e.g., the external electronic device 910a, the external electronic device 910b, or the communication link 915c). In operation 1210, the electronic device 405 (e.g., the processor 310) may perform audio relay negotiation for retransmission of audio data with the external electronic device 910 through the communication link. In an embodiment, the audio relay negotiation may determine at least one of a method of synchronizing, at least, the reception state for retransmission of the missing audio data (e.g., use of the reception identification information and/or the transmission period of the reception identification information) or a method of relaying the missing audio data. In an embodiment, the audio relay negotiation may be omitted.

In operation 1215, the electronic device 405 (e.g., the processor 310) may receive BIS connection information (e.g., at least a portion of the BIG information 500) in order to receive an audio service as a BIS sink role. In an embodiment, the electronic device 405 (e.g., the processor 310) may receive the BIG information directly from the source electronic device 400 providing the audio service or from the source electronic device 400 by an assistant of the external electronic device (e.g., the parent device or the external electronic device 910). In operation 1220, the electronic device 405 (e.g., the processor 310) may be synchronized with the BIG generated by the source electronic device 400 based on the BIG information and receive audio data (e.g., at least one BIS data packet) through one or more BISs in the BIG.

In operation 1225, the electronic device 405 (e.g., the processor 310) may transmit reception identification information for the at least one received BIS data packet to the external electronic device 910 through the communication link according to the result of the audio relay negotiation, or according to a method of synchronizing a predetermined reception state and a method of relaying missing audio data. In an embodiment, the reception identification information may be periodically transmitted whenever a designated number (e.g., one or more) of BIS data packets are received, immediately when missing audio data is generated (e.g., within the same BIS_spacing), or according to a predetermined period. In an embodiment, when the electronic device 405 fails to detect the preamble of the BIS data packet at the start time of a subevent, or when the BIS data packet received in the subevent has a CRC error, the electronic device 405 may determine that the BIS data packet is missing in the subevent and may not transmit the reception identification information corresponding to the BIS data packet to the external electronic device 910.

In an embodiment, instead of transmitting reception identification information for at least one successfully received BIS data packet, the electronic device 405 may transmit non-reception identification information for at least one missing BIS data packet to the external electronic device 910 through the communication link. After transmitting the non-reception identification information, the electronic device 405 may proceed to operation 1230 to monitor the reception of the relay data. When the electronic device 405 does not transmit the non-reception identification information, the electronic device 405 may omit operation 1230 until the reception time of the next BIS data packet.

In operation 1230, the electronic device 405 (e.g., the processor 310) may determine whether relay data (e.g., at least one BIS data packet) is received from the external electronic device 910. In an embodiment, the electronic device 405 (e.g., the processor 310) may receive the relay data at a time according to a method of relaying missing audio data, determined through the audio relay negotiation. In an embodiment, the electronic device 405 (e.g., the processor 310) may receive at least one BIS data packet including audio data for the audio service from the external electronic device 910. The at least one BIS data packet may be one that has been broadcast from the source electronic device 400 and omitted from the electronic device 405. When the relay data is received, in operation 1235, the electronic device 405 (e.g., the processor 310) may obtain audio data from the relay data (e.g., at least one BIS data packet).

In operation 1240, the electronic device 405 (e.g., the processor 310) may output audio data obtained from BIS data packets received from the source electronic device 400 and/or the external electronic device 910 through a speaker (e.g., the speaker 354) according to the rendering timing.

In operation 1245, the electronic device 405 (e.g., the processor 310) may determine whether the audio service is terminated, and if not, may return to operation 1220.

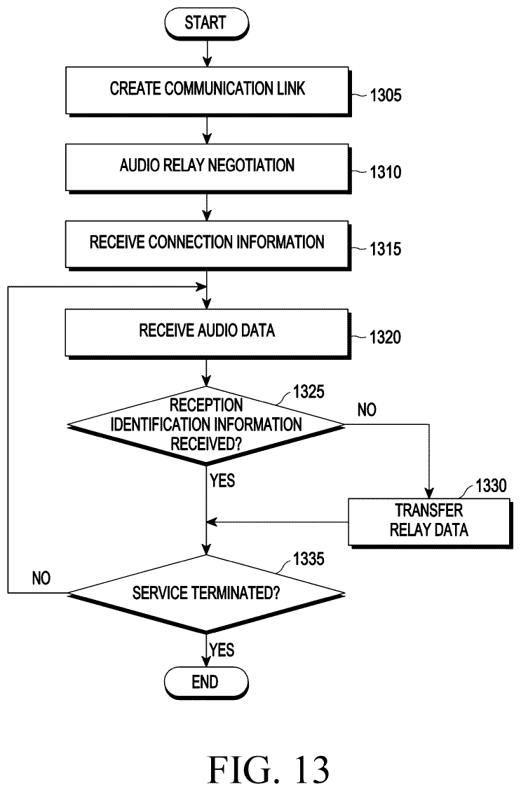

FIG. 13 is a flowchart illustrating an operation of an external electronic device receiving reception indication information according to an embodiment. According to embodiments, at least one of operations to be described below may be omitted, modified, or reordered. At least one of the operations described below may be executed by a processor (e.g., the processor 1010) of the external electronic device 910.

Referring to FIG. 13, in operation 1305, an external electronic device 910 (e.g., the processor 1010) may generate a communication link (e.g., a communication link 915a, a communication link 915b, or a communication link 915c) with the electronic device 405. In operation 1310, the external electronic device 910 (e.g., the processor 1010) may perform audio relay negotiation with the electronic device 405 through the communication link. In an embodiment, the audio relay negotiation may determine at least one of a method of synchronizing, at least, the reception state for relay of the missing audio data (e.g., use of the reception identification information and/or the transmission period of the reception identification information) or a method of relaying the missing audio data. In an embodiment, the audio relay negotiation may be omitted.

In operation 1315, the external electronic device 910 (e.g., the processor 1010) may receive BIS connection information (e.g., at least a portion of the BIG information 500) in order to receive an audio service as a BIS sink role. In an embodiment, the external electronic device 910 (e.g., the processor 1010) may receive the BIG information directly from the source electronic device 400 providing the audio service or from the source electronic device 400 by an assistant of the external electronic device (e.g., the parent device). In operation 1320, the electronic device 910 (e.g., the processor 1010) may be synchronized with the BIG generated by the source electronic device 400 based on the BIG information and receive audio data (e.g., at least one BIS data packet) through one or more BISs in the BIG. In an embodiment, the electronic device 910 (e.g., the processor 1010) may receive the audio data to support an audio relay, may store the audio data in the memory 1015 for a designated time without reproducing it, and may delete the audio data after the designated time. The electronic device 910 (e.g., the processor 1010) may perform operation 1325 within the designated time.

In operation 1325, the external electronic device 910 (e.g., the processor 1010) may determine whether reception identification information for the at least one BIS data packet received by the electronic device 405 is received from the electronic device 405 through the communication link according to the result of the audio relay negotiation, or according to a method of synchronizing a predetermined reception state and a method of relaying missing audio data. In an embodiment, the reception identification information may be transmitted immediately when missing audio data is generated (e.g., within the same BIS_spacing), or periodically according to a predetermined period. When the reception identification information is received, the external electronic device 910 (e.g., the processor 1010) may not transmit the at least one BIS data packet to the electronic device 405. In an embodiment, the external electronic device 910 (e.g., the processor 1010) may drop or flush the at least one BIS data packet corresponding to the reception identification information.

When the reception identification information is not received, in operation 1330, the external electronic device 910 (e.g., the processor 1010) may transmit relay data including the at least one BIS data packet to the electronic device 405. In an embodiment, the external electronic device 910 (e.g., the processor 1010) may transmit the relay data at a time according to a method of relaying missing audio data, determined through the audio relay negotiation.

In an embodiment, instead of performing operation 1325, the external electronic device 910 (e.g., the processor 1010) may receive non-reception identification information for at least one BIS data packet missing from the electronic device 405 from the electronic device 405 through the communication link. When the non-reception identification information is received, in operation 1330, the external electronic device 910 (e.g., the processor 1010) may transmit relay data including the at least one missing BIS data packet to the electronic device 405.

In operation 1340, the external electronic device 910 (e.g., the processor 1010) may determine whether the audio service is terminated, and if not, may return to operation 1320.

FIG. 14 is a view illustrating periodic advertising according to an embodiment.

Referring to FIG. 14, before the electronic device 405 performs an audio service, in operations 1402, 1406, and 1410, the source electronic device 400 may repeatedly transmit at least one packet (e.g., ADV_EXT_IND) including periodic advertising data through designated channels (e.g., channel 37, channel 38, and channel 39) every designated advertising interval. The ADV_EXT_IND may include auxiliary packet information indicating the position and channel information about the subsequent advertising packet (e.g., AUX_ADV_IND). In operation 1404, operation 1408, and operation 1412, the source electronic device 400 may transmit AUX_ADV_IND following the ADV_EXT_INDs. The AUX_ADV_IND may include information for a subsequent advertising packet (e.g., AUX_SYNC_IND), which may include BIG information (e.g., at least one of an access address, a channel map, an advertising interval, clock accuracy, or a time offset from AUX_ADV_IND).

In operation 1414, the source electronic device 400 may transmit AUX_SYNC_IND including BIG information (e.g., BIG information 500) before audio data for the audio service is transmitted. The AUX_SYNC_IND may include, e.g., BIG information in an ACAD field.

In an embodiment, the electronic device 405 may directly receive at least one of ADV_EXT_IND, AUX_ADV_IND, or AUX_SYNC_IND from the source electronic device 400. Although not illustrated, in an embodiment, the electronic device 405 may receive a link layer message (e.g., LL_PERIODIC_SYNC_IND) including synchronization information (Sync Info) for the AUX_SYNC_IND from the external electronic device 910 through the communication link (e.g., the communication link 915a, the communication link 915b, or the communication link 915c). In operation 1414, the electronic device 405 may receive AUX_SYNC_IND including BIG information from the source electronic device 400 based on the AUX_ADV_IND or the synchronization information.

The electronic device 405 may be synchronized with the BIG of the source electronic device 400 based on the BIG information, and may receive audio data through at least one BIS of the source electronic device 400. Although not shown, the external electronic device 910 may be synchronized with the BIG of the source electronic device 400 through a procedure similar to that of FIG. 14 and receive audio data through at least one BIS of the source electronic device 400.

FIG. 15 is a view illustrating audio relay negotiation according to an embodiment. Operations illustrated in an embodiment may correspond to operation 1106 of FIG. 11.

Referring to FIG. 15, the electronic device 405 may perform audio relay negotiation with the external electronic device 910 for missing audio data before or during an audio service as a BIS sink role. In an embodiment, the electronic device 405 may request an audio relay from the external electronic device 910 or perform audio relay negotiation according to a designated determination criterion. In an embodiment, the electronic device 405 may automatically request an audio relay or perform audio relay negotiation by a designated method. In an embodiment, the determination criterion may include at least one of when the reception quality of audio data is deteriorated (e.g., when the received signal strength or packet missing rate is smaller than a designated threshold), a designated period, a designated time interval, the user's intention, the signal strength of audio data, or a change in the surrounding wireless environment.

In operation 1505, the electronic device 405 may transmit information requesting a missing audio relay from the external electronic device 910 or a first link layer message (e.g., LL_BIS_RELAY_REQ) for requesting audio relay negotiation. In an embodiment, the first link layer message may include at least one of first information indicating a method of synchronizing the reception state or second information indicating a method of relaying missing audio data. In an embodiment, the first information (e.g., ‘1’) may mean that the reception indication information is transmitted for each BIS data packet. In an embodiment, the second information (e.g., ‘3’) may indicate the number of times when the missing audio data is repeatedly transmitted. In an embodiment, the first information may indicate whether the reception indication information includes reception identification information, non-reception identification information, or both. In operation 1510, the electronic device 405 may receive an ACK from the external electronic device 910.

In operation 1515, the electronic device 405 may transmit an empty packet in a designated transmission slot. When the external electronic device 910 does not accept the first information and the second information of the first link layer message, in operation 1520, the electronic device 405 may receive a second link layer message (e.g., LL_BIS_RELAY_RES) for audio relay negotiation from the external electronic device 910. In an embodiment, the second link layer message may include at least one of first information (e.g., ‘2’) or second information (e.g., ‘3’) requested by the external electronic device 910.

In operation 1525, the electronic device 405 may receive a third link layer message (e.g., LL_BIS_RELAY_IND) that accepts the first information (e.g., ‘2’) and the second information (e.g., ‘3’) requested by the external electronic device 910 from the external electronic device 910. In an embodiment, the third link layer message may include first information (e.g., ‘2’) and second information (e.g., ‘3’) allowed by the electronic device 405.

In operation 1530, the electronic device 405 may receive an ACK from the external electronic device 910 and perform an audio service based on the first information and the second information. In an embodiment, after the audio relay negotiation is completed in an embodiment, the electronic device 405 may transmit the reception indication information to the external electronic device 910 based on the first information, and may receive relay data from the external electronic device 910 based on the second information.

In an embodiment, the electronic device 405 and the external electronic device 910 may automatically perform audio relay negotiation according to various criteria based on the same user account. In an embodiment, the electronic device 405 and the external electronic device 910 may interwork on the same user account. When the electronic device 405 performs an audio service as a BIS sink role to receive audio data broadcast from the source electronic device 400, the account server may transfer information (e.g., at least one of first information for the method for synchronizing the reception state or the second information for the method of relaying the missing audio data) about the audio service of the electronic devices (e.g., the external electronic device 910) interworking on the same user account. The external electronic device 910 may be positioned near the electronic device 405, and may perform the operation of receiving the reception indication information for the electronic device 405 and transmitting the missing audio based on the information.

In an embodiment, the electronic device 405 and the external electronic device 910 may synchronize the reception state of audio data (e.g., at least one BIS data packet) immediately upon reception. After transmitting one BIS data packet, the source electronic device 400 may retransmit the same BIS data packet or the next BIS data packet after a time for minimum subevent space (T_MSS) (e.g., at least 150 μs). The electronic device 405 and the external electronic device 910 may share reception indication information within the T_MSS.

In an embodiment, the electronic device 405 may successfully receive one BIS data packet from the source electronic device 400 (e.g., without error), and may transmit reception indication information using at least one of the access address, PHY, or channel used by the source electronic device 400 to transmit the BIS data packet.

FIGS. 16A, 16B, and 16C are views illustrating a format of reception indication information according to an embodiment.

Referring to FIG. 16A, a first packet 1610 indicating reception indication information corresponding to the BIS data packet may be configured to include a preamble based on the BIS data packet. Although not shown, the first packet 1610 may include reception identification information and/or non-reception identification information in the payload.

Referring to FIG. 16B, the second packet 1620 indicating reception indication information corresponding to the BIS data packet may be configured to include a preamble and an access address based on the BIS data packet. The access address may be the same as the access address of the BIS data packet or the access address of the communication link (e.g., the communication link 915a, the communication link 915b, or the communication link 915c) established between the electronic device 405 and the external electronic device 910. Although not shown, the second packet 1620 may include reception identification information and/or non-reception identification information in the payload.

Referring to FIG. 16C, the third packet 1630 indicating reception indication information corresponding to the BIS data packet may include a preamble, an access address, and a payload header based on the BIS data packet. The access address may be the same as the access address of the BIS data packet or the access address of the communication link (e.g., the communication link 915a, the communication link 915b, or the communication link 915c) established between the electronic device 405 and the external electronic device 910. Although not shown, the third packet 1630 may include reception identification information and/or non-reception identification information in the payload.

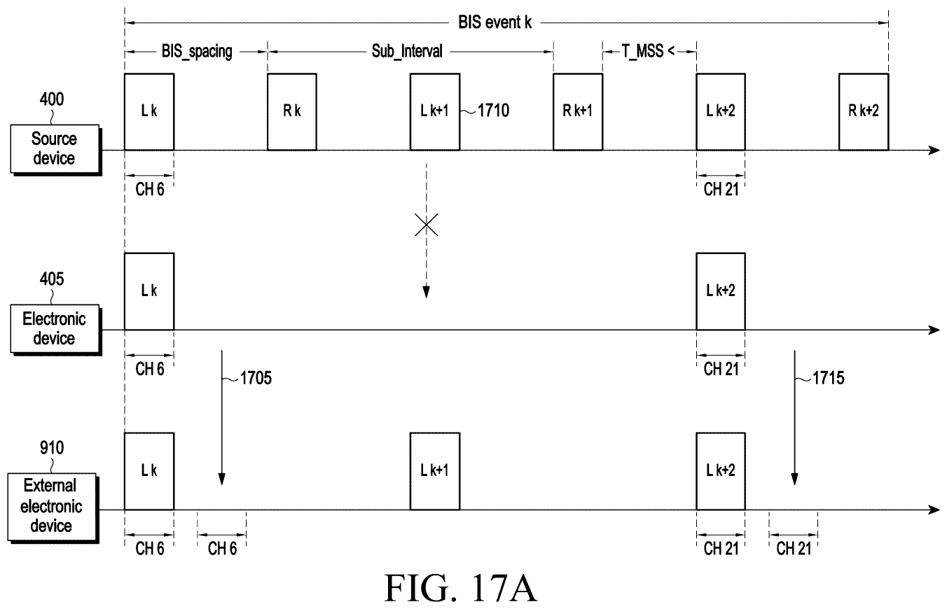

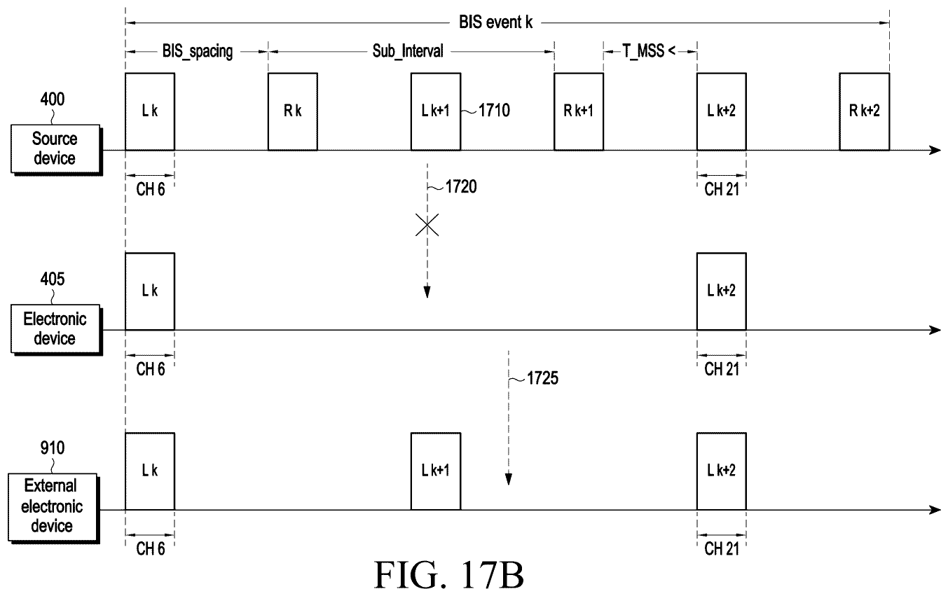

FIG. 17A is a view illustrating an operation of transmitting reception identification information according to an embodiment.

Referring to FIG. 17A, the source electronic device 400 may transmit a BIS data packet L_k, a BIS data packet R_k, a BIS data packet L_k+1, a BIS data packet R_k+1, a BIS data packet L_k+2, and a BIS data packet R_k+2 in a BIS event k. The electronic device 405 may be a left earbud, and may determine through audio relay negotiation with the external electronic device 910 to transmit reception identification information whenever each BIS data packet is received. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

The electronic device 405 may successfully receive the BIS data packet L_k and transmit the reception identification information 1705 to the external electronic device 910 before the designated reception time of the next data packet R_k belonging to the same audio service. In an embodiment, the reception identification information 1705 may be transmitted through the same channel (e.g., CH6) as used in the BIS data packet L_k within BIS_spacing including the BIS data packet L_k.

The electronic device 405 may fail to receive the BIS data packet L_k+1 1710, and accordingly, reception identification information corresponding to the BIS data packet L_k+1 1710 may not be transmitted within the BIS_spacing including the BIS data packet L_k+1 1710. The external electronic device 910 may successfully receive the BIS data packet L_k+1 1710, and as a result of monitoring the same channel (e.g., CH6) as used in the BIS data packet L_k+1 1710, identify that reception identification information corresponding to the BIS data packet L_k+1 1710 is not received from the electronic device 405.

The electronic device 405 may successfully receive the BIS data packet L_k+2, and transmit the reception identification information 1715 to the external electronic device 910 before the designated reception time of the next data packet R_k+2. In an embodiment, the reception identification information 1715 may be transmitted through the same channel (e.g., CH21) as used in the BIS data packet L_k+2 within BIS_spacing including the BIS data packet L_k+2.

FIG. 17B is a view illustrating an operation of transmitting non-reception identification information according to an embodiment.

Referring to FIG. 17B, the source electronic device 400 may transmit a BIS data packet L_k, a BIS data packet R_k, a BIS data packet L_k+1, a BIS data packet R_k+1, a BIS data packet L_k+2, and a BIS data packet R_k+2 in a BIS event k. The electronic device 405 may be a left earbud, and may determine through audio relay negotiation with the external electronic device 910 to transmit reception identification information whenever each BIS data packet is received. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream. The electronic device 405 may successfully receive the BIS data packet L_k.

The electronic device 405 may fail to receive the BIS data packet L_k+1 1720, and accordingly, may transmit non-reception identification information 1725 corresponding to the BIS data packet L_k+1 1720 within BIS_spacing including the BIS data packet L_k+1 1720. The external electronic device 910 may successfully receive the BIS data packet L_k+1 1720, and may identify that the electronic device 405 has failed to receive the BIS data packet L_k+1 1720 based on the reception of the non-reception identification information 1725 corresponding to the BIS data packet L_k+1 1720 from the electronic device 405 on the same channel (e.g., CH6) as used in the BIS data packet L_k+1 1720.

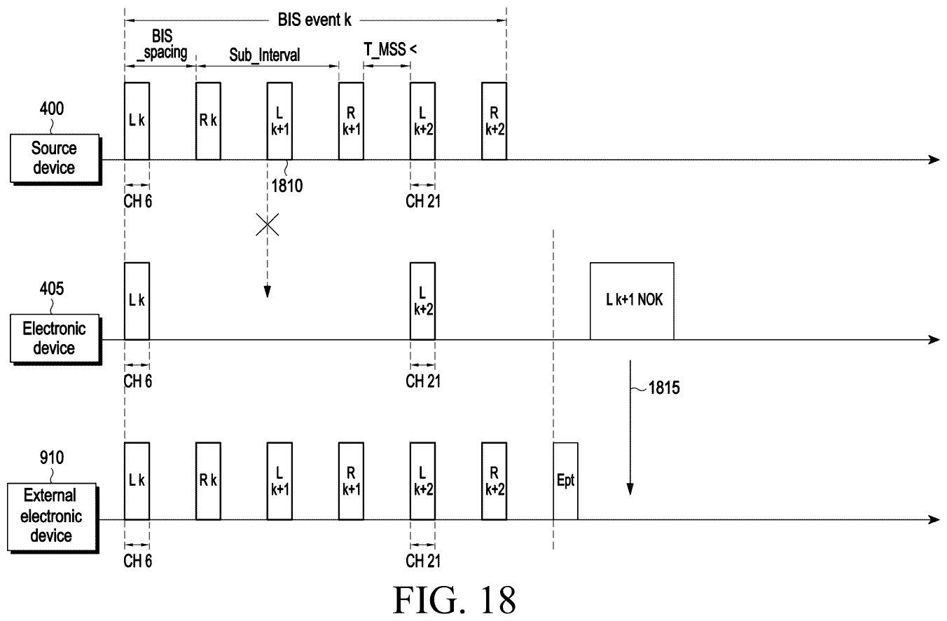

FIG. 18 is a view illustrating an operation of transmitting reception indication information after a BIS event according to an embodiment.

Referring to FIG. 18A, the source electronic device 400 may transmit a BIS data packet L_k, a BIS data packet R_k, a BIS data packet L_k+1, a BIS data packet R_k+1, a BIS data packet L_k+2, and a BIS data packet R_k+2 in a BIS event k. In an embodiment, the electronic device 405 may be a left earbud and may determine through audio relay negotiation with the external electronic device 910 to transmit reception indication information 1815 (e.g., reception identification information or non-reception identification information) corresponding to BIS data packets (e.g., BIS data packet L_k, BIS data packet L_k+1, and BIS data packet L_k+2) during one BIS event after each BIS event is terminated. The electronic device 405 and the external electronic device 910 may be in a state in which the start time of each BIS event is synchronized according to BIG information received from the source electronic device 400. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

In the BIS event k, the electronic device 405 successfully receives the BIS data packet L_k and the BIS data packet L_k+2, but may fail to receive the BIS data packet L_k+1 1810. After the BIS event k is terminated, e.g., in the BIS event k+1, the electronic device 405 may transmit the reception indication information 1815 to the external electronic device 910. In an embodiment, the reception indication information 1815 may include non-reception identification information (e.g., “L_k+1 NOK (not OK)” indicating the BIS data packet (e.g., BIS data packet L_k+1 1810)) missing in the BIS event k. In an embodiment, the reception indication information 1815 may include reception identification information (e.g., “L_k & L_k+2 OK”) indicating the BIS data packets (e.g., BIS data packet L_k and BIS data packet L_k+2) successfully received in the BIS event k.

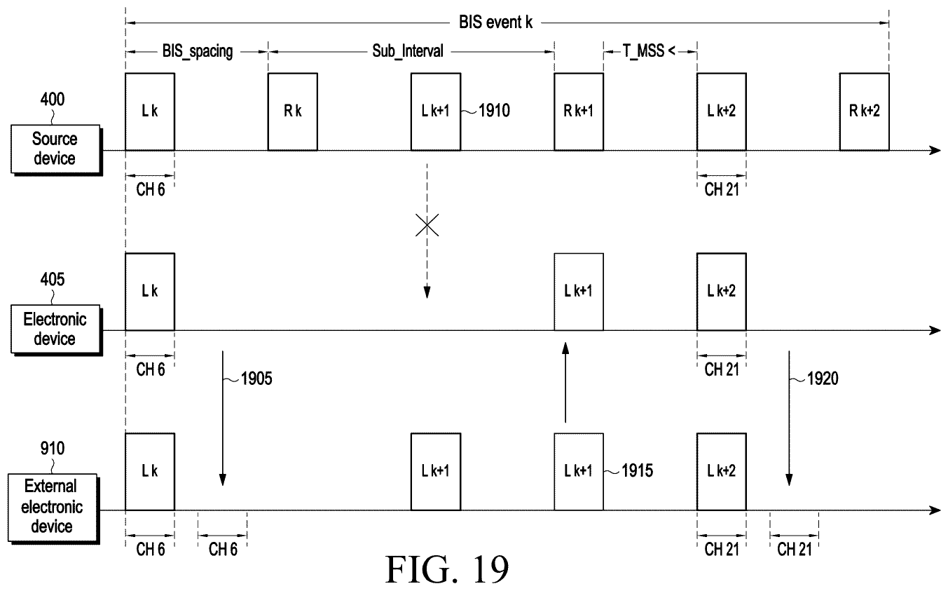

FIG. 19 is a view illustrating an operation of relaying missing audio data according to an embodiment.

Referring to FIG. 19, the source electronic device 400 may transmit a BIS data packet L_k, a BIS data packet R_k, a BIS data packet L_k+1, a BIS data packet R_k+1, a BIS data packet L_k+2, and a BIS data packet R_k+2 in a BIS event k. In an embodiment, the electronic device 405 may be a left earbud, and may determine through audio relay negotiation with the external electronic device 910 to relay missing audio data whenever non-reception of each BIS data packet is identified. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

The electronic device 405 may successfully receive the BIS data packet L_k and transmit the reception identification information 1905 to the external electronic device 910 before transmission of the next data packet (e.g., the BIS data packet R_k or L_k+1). In an embodiment, the reception identification information 1905 may be transmitted through the same channel (e.g., CH6) as used in the BIS data packet L_k within BIS_spacing including the BIS data packet L_k.

The electronic device 405 may fail to receive the BIS data packet L_k+1 1910, and accordingly, may not transmit reception indication information (e.g., reception identification information or non-reception identification information) (not shown) corresponding to the BIS data packet L_k+1 1910 within the BIS_spacing including the BIS data packet L_k+1 1910. The external electronic device 910 may successfully receive the BIS data packet L_k+1 1910 from the source electronic device 400, and as a result of monitoring the same channel (e.g., CH6) as used in the BIS data packet L_k+1 1910, identify that reception indication information (e.g., reception identification information or non-reception identification information) corresponding to the BIS data packet L_k+1 1910 is not received from the electronic device 405. In an embodiment, the external electronic device 910 may determine that the BIS data packet L_k+1 1910 is missing based on the reception indication information corresponding to the BIS data packet L_k+1 1910 being not received from the electronic device 405.

The electronic device 405 and the external electronic device 910 may determine in advance through audio relay negotiation so that the electronic device 405 transmits the missing audio data immediately (e.g., within the same BIS_Spacing). The external electronic device 910 may transmit (e.g., relay) the BIS data packet L_k+1 1915 including the payload of the BIS data packet L_k+1 1910 to the electronic device 405 based on identifying that the reception identification information corresponding to the BIS data packet L_k+1 1910 is not received. In an embodiment, the external electronic device 910 may transmit (e.g., relay) the BIS data packet L_k+1 1915 to the electronic device 405 within a time interval from the time of termination of the BIS data packet L_k+1 1910 to a designated time (e.g., 150 μs) before transmission of the next BIS data packet (e.g., BIS data packet L_k+2) starts.

In an embodiment, the BIS data packet L_k+1 1915 may include the same access address and payload as the BIS data packet L_k+1 1910. In an embodiment, the BIS data packet L_k+1 1915 may include the same payload as the BIS data packet L_k+1 1910, and may include an access address (e.g., different from the access address of the BIS data packet L_k+1 1910) of the communication link established between the electronic device 405 and the external electronic device 910.

The electronic device 405 may successfully receive the BIS data packet L_k+2 and transmit the reception identification information 1920 to the external electronic device 910 before transmission of the next data packet (e.g., the BIS data packet R_k+2). In an embodiment, the reception identification information 1920 may be transmitted through the same channel (e.g., CH21) as used in the BIS data packet L_k within BIS_spacing including the BIS data packet L_k+2.

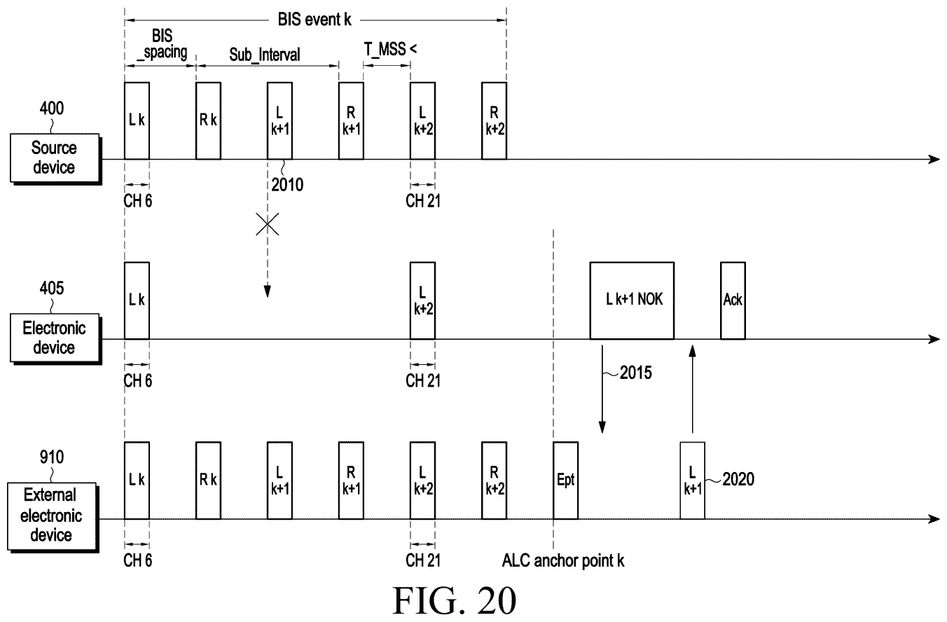

FIG. 20 is a view illustrating an operation of relaying missing audio data after a BIS event according to an embodiment.

Referring to FIG. 20, the source electronic device 400 may transmit a BIS data packet L_k, a BIS data packet R_k, a BIS data packet L_k+1, a BIS data packet R_k+1, a BIS data packet L_k+2, and a BIS data packet R_k+2 in a BIS event k. In an embodiment, the electronic device 405 may be a left earbud, and may determine through audio relay negotiation with the external electronic device 910 to relay missing audio data after the termination of each BIS event. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

In the BIS event k, the electronic device 405 successfully receives the BIS data packet L_k and the BIS data packet L_k+2, but may fail to receive the BIS data packet L_k+1 2010. After the BIS event k is terminated, e.g., in the BIS event k+1, the electronic device 405 may transmit the reception indication information 2015 to the external electronic device 910. In an embodiment, the reception indication information 2015 may include non-reception identification information (e.g., “L_k+1 NOK (not OK)” indicating the BIS data packet (e.g., BIS data packet L_k+1 2010)) missing in the BIS event k. In an embodiment, the reception indication information 2015 may include reception identification information (e.g., “L_k & L_k+2 OK”) indicating the BIS data packets (e.g., BIS data packet L_k and BIS data packet L_k+2) successfully received in the BIS event k.

The electronic device 405 and the external electronic device 910 may determine in advance through audio relay negotiation so that the electronic device 405 transmits the missing audio data according to a designated time interval or a designated period. In an embodiment, the designated time interval may be any time interval before the time when the missing audio data should be output from the electronic device 405, including a connection interval of communication link between the electronic device 405 and the external electronic device 910. In an embodiment, the designated period may be determined within a range in which sound missing of the electronic device 405 does not occur.

The external electronic device 910 may successfully receive the BIS data packet L_k+1 2010 from the source electronic device 400 within the BIS event k, and transmit (e.g., relay) the BIS data packet L_k+1 2020 to the electronic device 405 based on receiving the reception indication information 2015 within the next BIS event (e.g., BIS event k+1). In an embodiment, the BIS data packet L_k+1 2020 may include the same access address and payload as the BIS data packet L_k+1 2010. In an embodiment, the BIS data packet L_k+1 2020 may include the same payload as the BIS data packet L_k+1 2010, and may include an access address of the communication link established between the electronic device 405 and the external electronic device 910.

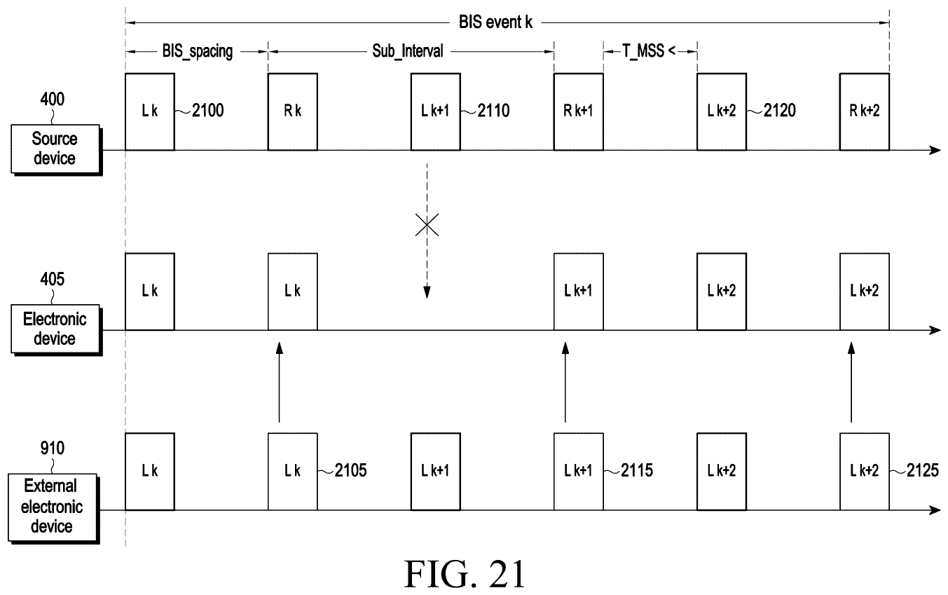

FIG. 21 is a view illustrating an operation of mandatorily relaying audio data by an external electronic device according to an embodiment.

Referring to FIG. 21, the source electronic device 400 may transmit a BIS data packet L_k 2100, a BIS data packet R_k, a BIS data packet L_k+1 2110, a BIS data packet R_k+1, a BIS data packet L_k+2 2120, and a BIS data packet R_k+2 in a BIS event k of the first BIG. In an embodiment, the electronic device 405 may be a left earbud and may request the external electronic device 910 through audio relay negotiation to relay the corresponding BIS data packet within the same Sub_interval whenever each BIS data packet is received. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

In an embodiment, the external electronic device 910 may relay, to the electronic device 400, BIS data packets (e.g., BIS data packet L_k 2105, BIS data packet L_k+1 2115, and BIS data packet L_k+2 2125) including the payloads of the BIS data packets (e.g., the BIS data packet L_k 2100, BIS data packet L_k+1 2110, and BIS data packet L_k+2 2120) received from the source electronic device 400 based on the first BIG information about the first BIG transmitted from the source electronic device 400. In an embodiment, the external electronic device 910 may generate a new second BIG (which may include a new access address or the same access address) different from the first BIG transmitted by the source electronic device 400, and relay, to the electronic device 400, the BIS data packets (e.g., BIS data packet L_k 2105, BIS data packet L_k+1 2115 and BIS data packet L_k+2 2125) including the payloads received from the source electronic device 400 through the first BIG.

In an embodiment, the external electronic device 910 may provide the second BIG information (e.g., synchronization information) about the second BIG to the electronic device 405 through the communication link (e.g., the communication link 915a, the communication link 915b, or the communication link 915c). The electronic device 405 may receive BIS data packets (e.g., BIS data packet L_k 2105, BIS data packet L_k+1 2115 and BIS data packet L_k+2 2125) relayed by the source electronic device 400 based on the second BIG information.

In the BIS event k, the electronic device 405 successfully receives the BIS data packet L_k 2100 and the BIS data packet L_k+2 2120, but may fail to receive the BIS data packet L_k+1 2110. The external electronic device 910 may receive the BIS data packet L_k 2100 from the source electronic device 400 and relay the BIS data packet L_k 2105 to the electronic device 405 in a designated time interval (e.g., a subevent in which the source electronic device 400 transmits the BIS data packet R_k) within the same sub_interval including the BIS data packet L_k 2100. The BIS data packet L_k 2105 may include the same payload as the BIS data packet L_k 2100 received from the source electronic device 400.

The external electronic device 910 may receive the BIS data packet L_k+1 2110 from the source electronic device 400 and relay, to the electronic device 405, the BIS data packet L_k+1 2115 in a designated time interval (e.g., a subevent in which the source electronic device 400 transmits the BIS data packet R_k+1) within the same Sub_interval including the BIS data packet L_k+1 2110. In an embodiment, the BIS data packet L_k+1 2115 may include the same access address and the same payload as the BIS data packet L_k+1 2110. In an embodiment, the BIS data packet L_k+1 2115 may include a different access address and the same payload as the BIS data packet L_k+1 2110.

The external electronic device 910 may receive the BIS data packet L_k+2 2120 from the source electronic device 300 and transfer the BIS data packet L_k+2 2125 to the electronic device 405 in a subsequent time period (e.g., a subevent in which the source electronic device 400 transfers the BIS data packet R_k+2). The BIS data packet L_k+2 2125 may include the same payload as the BIS data packet L_k+2 2100 received from the source electronic device 400.

In an embodiment, the electronic device 405 may receive the BIS data packet L_k+1 2115 from the external electronic device 910 in a designated time interval (e.g., a time interval when the BIS data packet R_k+1 is transmitted from the source electronic device 400) within the corresponding sub_interval in response to identifying that the BIS data packet L_k+1 2110 is missing. In an embodiment, the electronic device 405 may not receive the BIS data packets 2105 and 2125 from the external electronic device 910 in a designated time interval within the corresponding sub_interval in response to successfully receiving the BIS data packet L_k 2100 or the BIS data packet L_k+2 2120.

In an embodiment, the external electronic device 910 may receive BIS data packets (e.g., BIS data packets 2100, 2110, and 2120) from the source electronic device 400, and the external electronic device 910 may relay, to the electronic device 405, BIS data packets (e.g., BIS data packets 2105, 2115, and 2125) including the same payloads before the reproduction time of the BIS data packets 2100, 2110, and 2120 based on BIG_Sync_Delay of the BIS data packets 2100, 2110, and 2120.

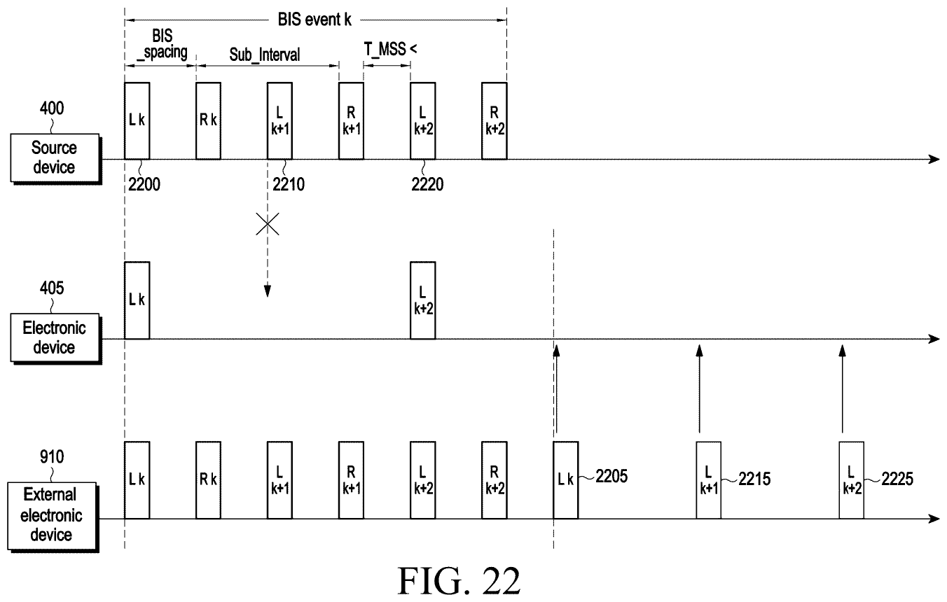

FIG. 22 is a view illustrating an operation of mandatorily relaying audio data based on BIS information about a source electronic device by an external electronic device according to an embodiment.

Referring to FIG. 22, the source electronic device 400 may transmit the BIS data packet L_k 2200, the BIS data packet R_k, the BIS data packet L_k+1 2210, the BIS data packet R_k+1, the BIS data packet L_k+2 2220, and the BIS data packet R_k+2 in the BIS event k. In an embodiment, the electronic device 405 may be a left earbud, and may request the external electronic device 910 through audio relay negotiation to relay the same BIS data packets after each BIS event is terminated. Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

In the BIS event k, the electronic device 405 successfully receives the BIS data packet L_k 2200 and the BIS data packet L_k+2 2220, but may fail to receive the BIS data packet L_k+1 2210. The external electronic device 910 may receive the BIS data packet L_k 2200, the BIS data packet L_k+1 2210, and the BIS data packet L_k+2 2220 within the BIS event k, and may relay the BIS data packet L_k 2205, the BIS data packet L_k+1 2215, and the BIS data packet L_k+2 2225 to the electronic device 405 in a next BIS event (e.g., the BIS event k+1). In an embodiment, the BIS data packet L_k 2205, the BIS data packet L_k+1 2215, and the BIS data packet L_k+2 2225 may include the same payload, and the same or different access address from the BIS data packet L_k 2200, the BIS data packet L_k+1 2210, and the BIS data packet L_k+2 2220 received from the source electronic device 400 by the external electronic device 910.

In an embodiment, the electronic device 405 may receive the BIS data packet L_k+1 2215 from the external electronic device 910 in the BIS event k+1 in response to identifying that the BIS data packet L_k+1 2210 is missing. In an embodiment, in response to successfully receiving the BIS data packet L_k 2200 or the BIS data packet L_k+2 2200, the electronic device 405 may not receive the BIS data packet L_k 2215 or the BIS data packet L_k+2 2225 from the external electronic device 910 through the second BIG within the corresponding BIS event (e.g., the BIS event k+1).

In an embodiment, the external electronic device 910 may receive BIS data packets (e.g., BIS data packets 2200, 2210, and 2220) from the source electronic device 400, and the external electronic device 910 may relay, to the electronic device 405, BIS data packets (e.g., BIS data packets 2205, 2215, and 2225) including the same payloads before the reproduction time of the BIS data packets 2200, 2210, and 2220 based on BIG_Sync_Delay of the BIS data packets 2200, 2210, and 2220.

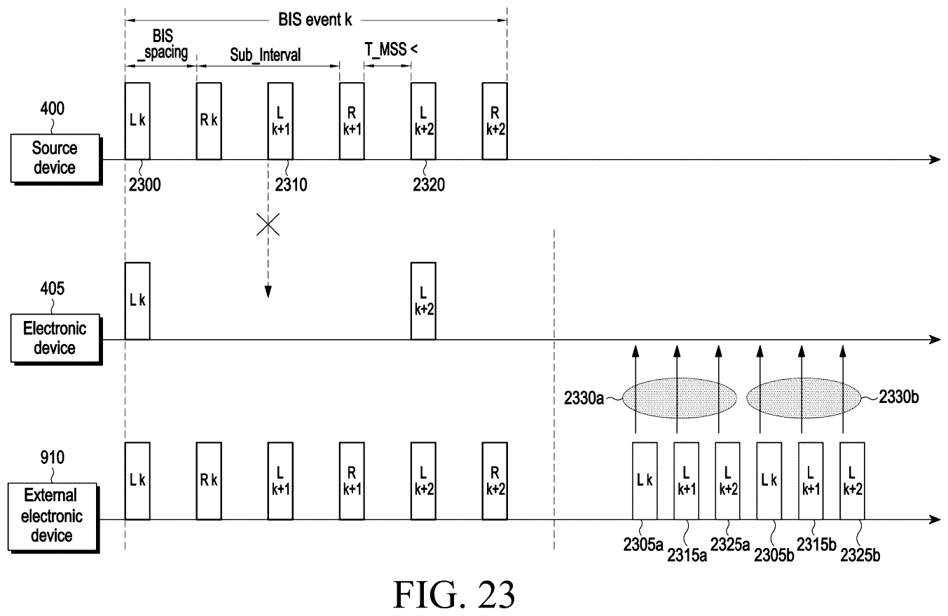

FIG. 23 is a view illustrating an operation of relaying audio data through a new BIG by an external electronic device according to an embodiment.

Referring to FIG. 23, the source electronic device 400 may transmit a BIS data packet L_k 2300, a BIS data packet R_k, a BIS data packet L_k+1 2310, a BIS data packet R_k+1, a BIS data packet L_k+2 2320, and a BIS data packet R_k+2 in a BIS event k of the first BIG. In an embodiment, the electronic device 405 may be a left earbud, and may request the external electronic device 910 through audio relay negotiation to relay BIS data packets using a new BIG (e.g., the second BIG). Although not shown, when the electronic device 405 is a right earbud, the external electronic device 910 may perform operations described below on the BIS data packets R_k, R_k+1, and R_k+2 of the right channel. In an embodiment, the data packets L_k, R_k, L_k+1, R_k+1, L_k+2, and R_k+2 may correspond to the same audio stream.

In the BIS event k, the electronic device 405 successfully receives the BIS data packet L_k 2300 and the BIS data packet L_k+2 2320, but may fail to receive the BIS data packet L_k+1 2310. After successfully receiving the BIS data packet L_k 2300, the BIS data packet L_k+1 2310, and the BIS data packet L_k+2 2320, the external electronic device 910 may transmit a first set 2330a including the BIS data packet L_k 2305a, the BIS data packet L_k+1 2315a, and the BIS data packet L_k+2 2325a, and a second set 2330b including the BIS data packet L_k 2305b, the BIS data packet L_k+1 2315b, and the BIS data packet L_k+2 2325b, through the second BIG. In an embodiment, the external electronic device 910 includes the first set 2330a and the second set 2330b, and may repeatedly transmit as many identical sets as possible within the remaining interval except for the time interval when the source device 400 transmits data.

In an embodiment, the BIS data packets (e.g., BIS data packets 2305a, 2315a, and 2325a) of the first set 2330a transferred by the external electronic device 910 may include the same payload, and the same or different access address from the BIS data packets (e.g., BIS data packet L_k 2300, BIS data packet L_k+1 2310, and BIS data packet L_k+2 2320) received by the external electronic device 910 from the source electronic device 400. The external electronic device 910 may sequentially transmit the BIS data packets 2305a, 2315a, and 2325a according to a designated time interval. The BIS data packets (e.g., BIS data packets 2305b, 2315b, and 2325b) of the second set 2330b transferred by the external electronic device 910 may include the same payload and the same or different access address from the BIS data packets (e.g., BIS data packet L_k 2300, BIS data packet L_k+1 2310, and BIS data packet L_k+2 2320) received by the external electronic device 910 from the source electronic device 400. The external electronic device 910 may sequentially transmit the BIS data packets 2305b, 2315b, and 2325b according to a designated time interval.

In an embodiment, the external electronic device 910 may receive BIS data packets (e.g., BIS data packets 2300, 2310, and 2320) through the first BIG, and the external electronic device 910 may relay BIS data packets (e.g., BIS data packets 2305a, 2315a, 2325a, 2305b, 2315b, and 2325b) including the same payloads to the electronic device 405 through the second BIG before the reproduction time of the BIS data packets 2300, 2310, and 2320 based on the BIG_Sync_Delay of the BIS data packets 2300, 2310, and 2320.

In an embodiment, the electronic device 405 may receive only the missing BIS data packet L_k+1 (e.g., at least one of the BIS data packet L_k+1 2315a or the BIS data packet L_k+1 2315b) from the external electronic device 910, except for the BIS data packets L_k and L_k+2 that have been successfully received from the source device 400. When the electronic device 405 successfully receives the BIS data packet L_k+1 2315a, the electronic device 405 may not receive the BIS data packet L_k+1 2315b.

In an embodiment, the electronic device 405 and the external electronic device 910 may share reception indication information (e.g., reception identification information) immediately when receiving audio data (e.g., at least one BIS data packet), and may determine through audio relay negotiation to transfer the missing BIS data packet immediately when the missing BIS data packet is detected. In an embodiment, the electronic device 405 may activate the reception circuit of the communication circuitry 320 at the start time of the subevent for receiving the audio data. In an embodiment, the electronic device 405 may successfully receive a BIS data packet of a subevent and transmit reception indication information (e.g., reception identification information) corresponding to the BIS data packet to the external electronic device 910 during the subevent.

When the external electronic device 910 does not receive the reception identification signal from the electronic device 405, the external electronic device 910 may determine that the electronic device 405 has not received the audio data (e.g., missing). From the time of receiving the reception identification signal from the electronic device 405, the external electronic device 910 may transmit (e.g., relay) audio data corresponding to the reception identification signal to the electronic device 405 for an arbitrary time interval before the next audio data is transmitted from the source electronic device 400 from the time of receiving the reception identification information.

An electronic device 405 according to an embodiment may comprise communication circuitry 320 and at least one processor 310 operatively connected, directly or indirectly, to the communication circuitry. The at least one processor may be configured to establish a communication link with an external electronic device 910 through the communication circuitry. The at least one processor may be configured to perform audio relay negotiation for an audio service with the external electronic device through the communication link. The at least one processor may be configured to receive at least one first data packet broadcast from a source electronic device. The at least one processor may be configured to transmit reception indication information related to the audio service to the external electronic device through the communication link based on the audio relay negotiation. The at least one processor may be configured to receive, from the external electronic device, relay data including at least one second data packet received from the source electronic device by the external electronic device based on the audio relay negotiation. The at least one processor may be configured to output an audio based on the at least one first data packet and the at least one second data packet.

In an embodiment, the at least one processor may be configured to, through the audio relay negotiation, determine at least one of information indicating whether the reception indication information includes reception identification information, non-reception identification information, or both the reception identification information and the non-reception identification information, a time of transmitting the reception indication information, or a time of receiving the relay data.

In an embodiment, the at least one second data packet may have an access address different from an access address of the at least one first data packet.

In an embodiment, the at least one processor may be configured to transmit the reception indication information after receiving the at least one first data packet and before a designated reception time of a next data packet subsequent to the at least one first data packet during the audio service.

In an embodiment, the at least one processor may be configured to receive the at least one first data packet and transmit the reception indication information at a designated time within a next BIS event

In an embodiment, the at least one processor may be configured to transmit the reception indication information through the same physical channel as a physical channel of the at least one first data packet.

An electronic device 910 according to an embodiment may comprise communication circuitry 1005 and at least one processor 1010 operatively connected, directly or indirectly, to the communication circuitry. The at least one processor may be configured to establish a communication link with an external electronic device 405 through the communication circuitry. The at least one processor may be configured to perform audio relay negotiation for an audio service with the external electronic device through the communication link. The at least one processor may be configured to receive at least one first data packet broadcast from a source electronic device. The at least one processor may be configured to identify whether reception indication information related to the audio service is received from the external electronic device through the communication link based on the audio relay negotiation. The at least one processor may be configured to transmit, to the external electronic device, relay data including the at least one first data packet received from the source electronic device based on the audio relay negotiation, based on the reception indication information.

In an embodiment, the at least one processor may be configured to, through the audio relay negotiation, determine at least one of information indicating whether the reception indication information includes reception identification information, non-reception identification information, or both the reception identification information and the non-reception identification information, a time of receiving the reception indication information, or a time of transmitting the relay data.

In an embodiment, the at least one processor may be configured to identify whether the reception indication information is received on the same physical channel as a physical channel of the at least one first data packet after receiving the at least one first data packet and before receiving a next data packet of the at least one first data packet.

In an embodiment, the at least one processor may be configured to receive the at least one first data packet and identify whether the reception indication information is received on the same physical channel as the physical channel of the at least one first data packet at a designated time within a next BIS event.

A method for operating an electronic device 405 according to an embodiment may comprise connecting (1205) a communication link with an external electronic device 910. The method may comprise performing (1210) audio relay negotiation for an audio service with the external electronic device through the communication link. The method may comprise receiving (1220) at least one first data packet broadcast from a source electronic device. The method may comprise transmitting (1225) reception indication information related to the audio service to the external electronic device through the communication link based on the audio relay negotiation. The method may comprise receiving (1230), from the external electronic device, relay data including at least one second data packet received from the source electronic device by the external electronic device based on the audio relay negotiation. The method may comprise outputting (1245) an audio based on the at least one first data packet and the at least one second data packet.

In an embodiment, the audio relay negotiation may include determining at least one of information indicating whether the reception indication information includes reception identification information, non-reception identification information, or both the reception identification information and the non-reception identification information, a time of transmitting the reception indication information, or a time of receiving the relay data.

In an embodiment, the at least one second data packet may have an access address different from an access address of the at least one first data packet.

In an embodiment, the reception indication information may be transmitted after receiving the at least one first data packet and before receiving a next data packet of the at least one first data packet.

In an embodiment, the reception indication information may be transmitted at a designated time within a next BIS event after receiving the at least one first data packet.

In an embodiment, the reception indication information may be transmitted through the same physical channel as a physical channel of the at least one first data packet.

A method for operating an electronic device 910 according to an embodiment may comprise connecting (1305) a communication link with an external electronic device 405. The method may comprise performing (1310) audio relay negotiation for an audio service with the external electronic device through the communication link. The method may comprise receiving (1320) at least one first data packet broadcast from a source electronic device. The method may comprise identifying (1325) whether reception indication information related to the audio service is received from the external electronic device through the communication link based on the audio relay negotiation. The method may comprise transmitting (1330), to the external electronic device, relay data including the at least one first data packet received from the source electronic device based on the audio relay negotiation, based on the reception indication information. “Based on” as used herein covers based at least on.

In an embodiment, the audio relay negotiation may include determining at least one of information indicating whether the reception indication information includes reception identification information, non-reception identification information, or both the reception identification information and the non-reception identification information, a time of receiving the reception indication information, or a time of transmitting the relay data.

In an embodiment, the reception indication information may be received on the same physical channel as a physical channel of the at least one first data packet after receiving the at least one first data packet and before receiving a next data packet of the at least one first data packet.

In an embodiment, the reception indication information may be received on the same physical channel as the physical channel of the at least one first data packet at a designated time within a next broadcast isochronous stream (BIS) event after receiving the at least one first data packet.

The electronic device according to various example embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., the memory 390, internal memory 136 or external memory 138) that is readable by a machine (e.g., the electronic device 202 or 204 or the electronic device 101). For example, a processor (e.g., the processor 310 or processor 120) of the machine (e.g., the electronic device 202 or 204 or electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various example embodiments may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device, comprising:
memory storing instructions;
communication circuitry; and
at least one processor, comprising processing circuitry, operatively connected to the communication circuitry, wherein
the instructions, when executed by the at least one processor individually and/or collectively, cause the electronic device to:
establish a communication link with an external electronic device through at least the communication circuitry;
perform at least part of an audio relay negotiation for an audio service with the external electronic device through the communication link;
receive at least one first data packet broadcast from a source electronic device;
control to transmit reception indication information related to the audio service to the external electronic device through at least the communication link based on the audio relay negotiation;
receive, from the external electronic device, relay data including at least one second data packet received from the source electronic device by the external electronic device based on the audio relay negotiation; and
output an audio based on the at least one first data packet and the at least one second data packet.

2. The electronic device of claim 1, wherein the instructions, when executed by the at least one processor individually or collectively, cause the electronic device to, through the audio relay negotiation, determine at least one of:
information indicating whether the reception indication information includes reception identification information, non-reception identification information, or both the reception identification information and the non-reception identification information;
a time of transmitting the reception indication information; or
a time of receiving the relay data.

3. The electronic device of claim 1, wherein the at least one second data packet has an access address different from an access address of the at least one first data packet.

4. The electronic device of claim 1, wherein the instructions, when executed by the at least one processor individually and/or collectively, cause the electronic device to transmit the reception indication information after receiving the at least one first data packet and before a designated reception time of a next data packet subsequent to the at least one first data packet during the audio service.

5. The electronic device of claim 1, wherein the instructions, when executed by the at least one processor individually and/or collectively, cause the electronic device to receive the at least one first data packet and transmit the reception indication information at a designated time within a next broadcast isochronous stream (BIS) event

6. The electronic device of claim 1, wherein the instructions, when executed by the at least one processor individually and/or collectively, cause the electronic device to transmit the reception indication information through the same physical channel as a physical channel of the at least one first data packet.

7. An electronic device, comprising:
memory storing instructions;
communication circuitry; and
at least one processor, comprising processing circuitry, operatively connected to the communication circuitry, wherein the instructions, when executed by the at least one processor individually and/or collectively, cause the electronic device to:
establish a communication link with an external electronic device through at least the communication circuitry;
perform at least part of an audio relay negotiation for an audio service with the external electronic device through at least the communication link;
receive at least one first data packet broadcast from a source electronic device;
identify whether reception indication information related to the audio service is received from the external electronic device through the communication link based on the audio relay negotiation; and
control to transmit, to the external electronic device, relay data including the at least one first data packet received from the source electronic device based on the audio relay negotiation, based on the reception indication information.

8. The electronic device of claim 7, wherein the instructions, when executed by the at least one processor individually and/or collectively, cause the electronic device to, through the audio relay negotiation, determine at least one of:
information indicating whether the reception indication information includes reception identification information, non-reception identification information, or both the reception identification information and the non-reception identification information;
a time of receiving the reception indication information; or
a time of transmitting the relay data.

9. The electronic device of claim 7, wherein the instructions, when executed by the at least one processor individually and/or collectively, cause the electronic device to identify whether the reception indication information is received on the same physical channel as a physical channel of the at least one first data packet after receiving the at least one first data packet and before receiving a next data packet of the at least one first data packet.

10. The electronic device of claim 7, wherein the instructions, when executed by the at least one processor is individually and/or collectively, cause the electronic device to receive the at least one first data packet and identify whether the reception indication information is received on the same physical channel as the physical channel of the at least one first data packet at a designated time within a next broadcast isochronous stream (BIS) event.

11. A method for operating an electronic device, the method comprising:
connecting a communication link with an external electronic device;
performing at least part of an audio relay negotiation for an audio service with the external electronic device through at least the communication link;
receiving at least one first data packet broadcast from a source electronic device;
transmitting reception indication information related to the audio service to the external electronic device through at least the communication link based on the audio relay negotiation;
receiving, from the external electronic device, relay data including at least one second data packet received from the source electronic device by the external electronic device based on the audio relay negotiation; and
outputting an audio based on the at least one first data packet and the at least one second data packet.

12. The method of claim 11, wherein the audio relay negotiation includes determining at least one of:
information indicating whether the reception indication information includes reception identification information, non-reception identification information, or both the reception identification information and the non-reception identification information;
a time of transmitting the reception indication information; or
a time of receiving the relay data.

13. The method of claim 11, wherein the at least one second data packet has an access address different from an access address of the at least one first data packet.

14. The method of claim 11, wherein the reception indication information is transmitted after receiving the at least one first data packet and before a designated reception time of a next data packet subsequent to the at least one first data packet during the audio service.

15. The method of claim 11, wherein the reception indication information is transmitted at a designated time within a next broadcast isochronous stream (BIS) event after receiving the at least one first data packet.

16. The method of claim 11, wherein the reception indication information is transmitted through the same physical channel as a physical channel of the at least one first data packet.

17. A method for operating an electronic device, the method comprising:
connecting via a communication link with an external electronic device;
performing at least part of an audio relay negotiation for an audio service with the external electronic device through at least the communication link;
receiving at least one first data packet broadcast from a source electronic device;
identifying whether reception indication information related to the audio service is received from the external electronic device through the communication link based on the audio relay negotiation; and
transmitting, to the external electronic device, relay data including the at least one first data packet received from the source electronic device based on the audio relay negotiation, based on the reception indication information.

18. The method of claim 17, wherein the audio relay negotiation includes determining at least one of:
information indicating whether the reception indication information includes reception identification information, non-reception identification information, or both the reception identification information and the non-reception identification information;
a time of receiving the reception indication information; or
a time of transmitting the relay data.

19. The method of claim 17, wherein the reception indication information is received on the same physical channel as a physical channel of the at least one first data packet, after receiving the at least one first data packet and before receiving a next data packet of the at least one first data packet.

20. The method of claim 17, wherein the reception indication information is received on the same physical channel as the physical channel of the at least one first data packet at a designated time within a next broadcast isochronous stream (BIS) event after receiving the at least one first data packet.
